(19) United States
(12) Patent Application Publication
(10) Pub. No.: US 2026/0181547 A1
(43) Pub. Date: Jun. 25, 2026

(54) LP-WUS COVERAGE EXTENSION BY SIGNAL RELAYING

(71) Applicant: InterDigital Patent Holdings, Inc., Wilmington, DE (US)

(72) Inventors: Jongwoo Hong, New York, NY (US); Young Woo Kwak, Woodbury, NY (US); Moon IL Lee, Melville, NY (US); Prasanna Herath, Laval (CA); Nazli Khan Beigi, Longueuil (CA); Brian Martin, Farnham (GB); Virgile Garcia, Antibes (FR)

(73) Assignee: InterDigital Patent Holdings, Inc., Wilmington, DE (US)

(21) Appl. No.: 18/990,400

(22) Filed: Dec. 20, 2024

(51) Int. Cl. H04W 52/02; H04W 8/22; H04W 24/10

(52) U.S. Cl. CPC H04W 52/0229; H04W 8/22; H04W 24/10

(57) ABSTRACT

In some implementations, a WTRU may include transmitting capability information to support LP-WUS forwarding, and receiving a configuration message to enable LP-WUS coverage extension for a remote WTRU, the configuration message including, first configuration parameters for monitoring a LP-WUS of the remote WTRU, the first configuration parameters including configured resources for the remote WTRU, second configuration parameters for LP-WUS transmission forwarding to the remote WTRU, and third configuration information indicating signal quality parameters for relaying a LP-WUS to the remote WTRU. The WTRU may include receiving an indication to start monitoring the LP-WUS of the remote WTRU, determining the signal quality parameters for relaying the LP-WUS are satisfied, and transmitting an acknowledgement for activation of LP-WUS. The WTRU may include monitoring for a LP-WUS, receiving a LP-WUS for the remote WTRU, determining uplink (UL) resources for transmitting the received LP-WUS, and transmitting the received LP-WUS to the remote.

### BACKGROUND

In current and next generation wireless systems, low-power wake-up signals (LP-WUS) are a feature designed to improve the energy efficiency of devices, particularly user equipment (UE) like smart phones, IoT devices, and other battery powered equipment. A LP-WUS allows devices in idle or inactive states to conserve battery life by reducing the need for continuous monitoring of control channels. These signals enable devices to transition from a low-power state to an active state only when necessary. A WUS is a specific signal sent before paging occasions (POs) in a connected network. The WUS alerts the device to wake-up and prepare for potential communication on a physical downlink control channel (PDCCH). A device, for example a UE, may have two radios, one radio may be a low-power radio or low-power wake-up radio and the other radio may be a main radio that is activated by the low-power radio. Devices that may be at a cell edge or experiencing a weak network signal may be under main radio coverage, but not activating low-power monitoring due to marginal signal coverage. Consequently, these devices cannot take advantage of the improved energy efficiency provided by the low-power radio.

Thus, the need exists for a technological solution to extend the coverage of the low-power radio in devices that may have main radio coverage but weak or no low-power radio coverage or an imbalance in coverage between the low-power radio and main radio.

### SUMMARY

In one general aspect, a method may include transmitting, to a wireless network, capability information indicating a capability to support low power wake-up signal (LP-WUS) forwarding. The method may also include receiving, from the wireless network, a configuration message for a remote WTRU to enable LP-WUS coverage extension for the remote WTRU, the configuration message including, first configuration parameters for monitoring a LP-WUS of the remote WTRU where the first configuration parameters include remote WTRU configured resources, second configuration parameters for LP-WUS transmission forwarding to the remote WTRU include a resource mapping configuration, and third configuration information indicating signal quality parameters for relaying a received LP-WUS to the remote WTRU. The method may furthermore include receiving, from the wireless network, an indication to start monitoring the LP-WUS of the remote WTRU, and determining that the signal quality parameters for relaying a received LP-WUS are satisfied. The method may moreover include transmitting, to the wireless network, an acknowledgement for activation of LP-WUS relaying in response to the indication to start monitoring the LP-WUS of the remote WTRU. The method may also include monitoring for a LP-WUS based on the remote WTRU configured resources and a low power synchronization signal (LP-SS) transmitted to the remote WTRU using the remote WTRU configured resources. The method may furthermore include receiving, from the wireless network, a LP-WUS addressed to the remote WTRU, and determining uplink (UL) resources for transmitting the received LP-WUS to the remote WTRU according to a mapping between resources of the received LP-WUS and configured UL resources based on the resource mapping configuration. The method may moreover include transmitting the received LP-WUS to the remote WTRU according to the determined UL resources. Other embodiments of this aspect include corresponding computer systems, apparatus, and computer programs recorded on one or more computer storage devices, each configured to perform the actions of the methods.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an illustration of simplified receiver architecture of a WTRU utilizing a low-power wake-up receiver;

FIG. 3 is an illustration of an example WTRU relay implementation for extending LP-WUS coverage;

FIG. 4 is an illustration of an example idle mode wake-up signal monitoring;

FIG. 5A illustrates WTRU power consumption in 3GPP Rel-16;

FIG. 5B illustrates WTRU power consumption in 3GPP Rel-17 using PEI;

FIG. 5C illustrates WTRU power consumption in 3GPP Rel-17 using PEI and TRS;

FIG. 6 is a flow diagram of an example LP-WUS coverage extension process according to an embodiment;

FIG. 7 is a flow diagram of an example for LP-WUS coverage extension process with a sidelink according to an embodiment; and

FIG. 8 is a flowchart of an example LP-WUS coverage extension process according to an embodiment.

### DETAILED DESCRIPTION

### Abbreviations and Acronyms

ACK Acknowledgement
BLER Block Error Rate
BWP Bandwidth Part
C-DRX Connected mode DRX
CE Control Element
CG Configured grant or cell group
CP Cyclic Prefix
CP-OFDM Conventional OFDM (relying on cyclic prefix)
CQI Channel Quality Indicator
CQI Channel Quality Information
CRC Cyclic Redundancy Check
CRI CSI-RS Resource Indicator
CSI Channel State Information
CSI Channel State Information
DCI Downlink Control Information
DCI Downlink Control Information
DFI Downlink feedback information
DG Dynamic grant
DL Downlink
DM-RS Demodulation Reference Signal
DRB Data Radio Bearer
DRX Discontinuous Reception
HARQ Hybrid Automatic Repeat Request
LI Layer Indicator
LP Low Power
LO LP-WUS occasions
LR Low power Radio
LTE Long Term Evolution e.g. from 3GPP LTE R8 and up
MAC Medium Access Control
MCS Modulation and Coding Scheme
MIMO Multiple Input Multiple Output
MO LP-WUS Monitoring Occasion
MR Main Radio
NACK Negative ACK
NR New Radio
NW Network
OFDM Orthogonal Frequency-Division Multiplexing
P(U/D)CCH Physical Uplink/Downlink Control Channel
P(U/D)SCH Physical Uplink/Downlink Shared Channel
PBCH Physical Broadcast Channel
PHY Physical Layer
PMI Precoding Matrix Indicator
PO Paging Occasion
PRACH Physical Random Access Channel
PSS Primary Synchronization Signal
RA Random Access (or procedure)
RACH Random Access Channel
RAR Random Access Response
RCU Radio access network Central Unit
RF Radio Front end
RI Rank Indicator
RLF Radio Link Failure
RLM Radio Link Monitoring
RNTI Radio Network Identifier
RO RACH occasion
RRC Radio Resource Control
RRM Radio Resource Management
RRM Radio Resource Management
RS Reference Signal
RS Reference Signal
RSRP Reference Signal Received Power
RSRP Reference Signal Received Power
RSSI Received Signal Strength Indicator
SDU Service Data Unit
SPS Semi-persistent scheduling
SRS Sounding Reference Signal
SRS Sounding Reference Signal
SS Synchronization Signal
SS Synchronization Signal
SSBRI SS/PBCH Resource Block Indicator
SSS Secondary Synchronization Signal
SUL Supplemental Uplink
SWG Switching Gap (in a self-contained subframe)
TB Transport Block
TBS Transport Block Size
TRP Transmission/Reception Point
TSC Time-sensitive communications
TSN Time-sensitive networking
UL Uplink
URLLC Ultra-Reliable and Low Latency Communications
WBWP Wide Bandwidth Part
WLAN Wireless Local Area Networks and related technologies (IEEE 802.xx domain)
WUR Wake up Radio
WUS Wake up Signal

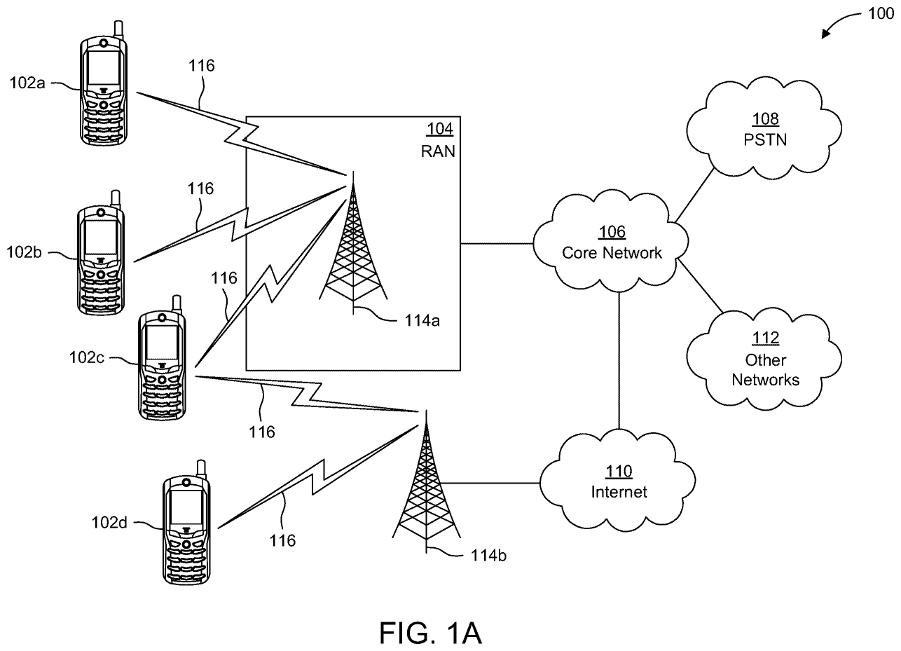

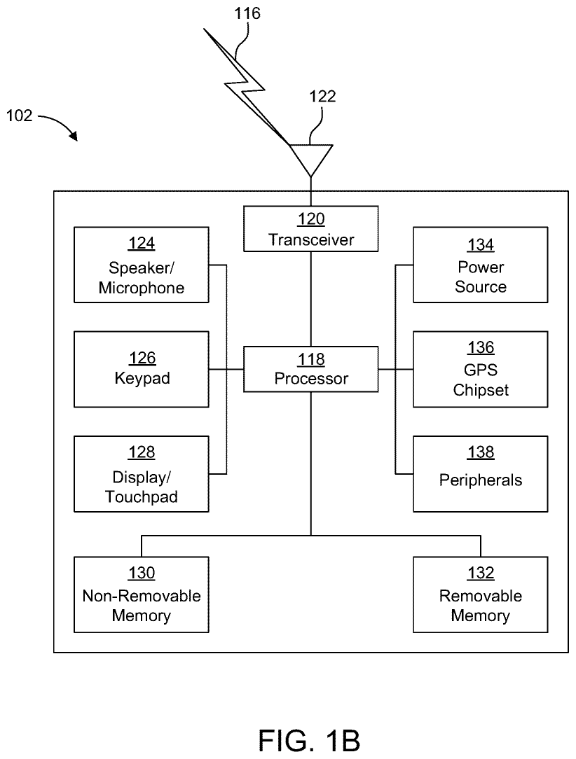

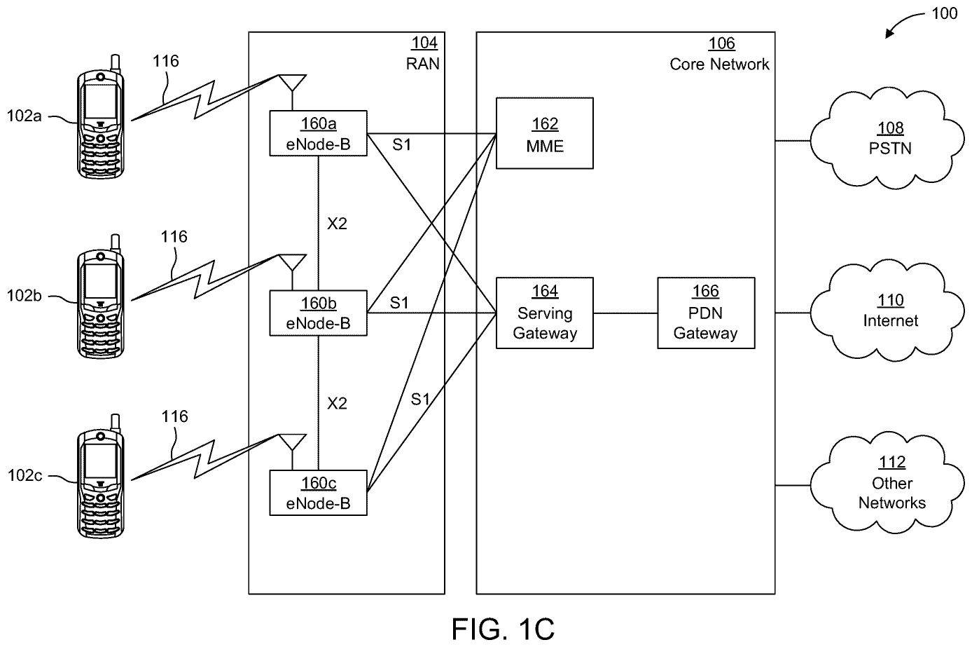

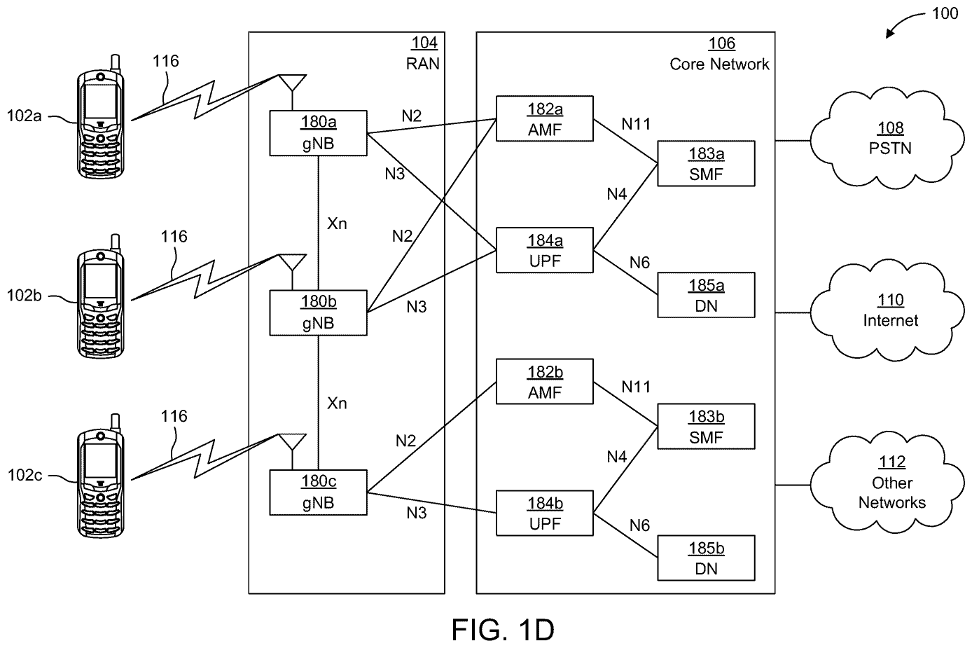

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may monitor and receive a wake-up signal (WUS) via a first radio (e.g., a low-power or ultra-low power radio). The WUS may be called a low-power WUS (LP-WUS). The first radio may be called a low-power radio (LR) or a low power wake-up radio (LP-WUR). Received WUS (e.g., an LP-WUS), for example via LR, may trigger wake-up or use of a second radio of the WTRU (e.g., the WTRU's main radio (MR)) for data and/or control signal transmission and/or reception. This has the potential to reduce the power consumption of wireless devices.

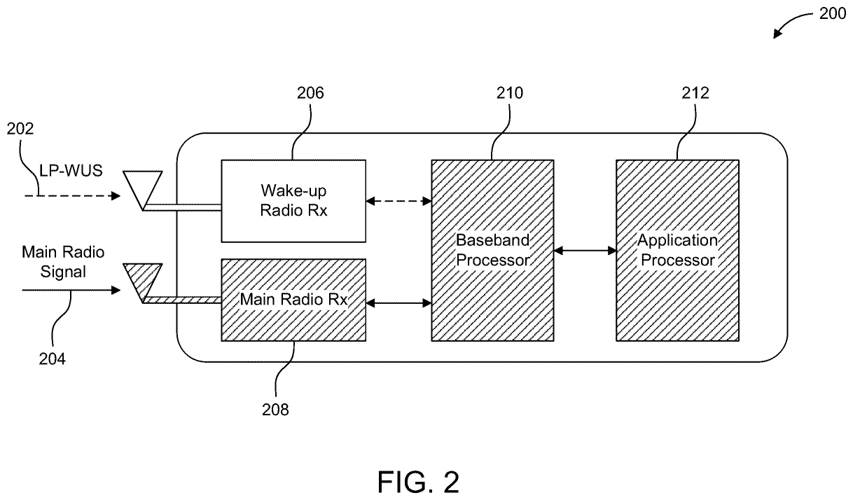

FIG. 2 illustrates a simplified receiver architecture of a WTRU utilizing a low-power wake-up receiver. A LP-WUS 202 may be received by LR 206. The low-power signal may be received while a WTRU is in a low-power state and used to wake-up the main radio. LP-WUS 202 may be processed by baseband processor 210 and application processor 212. Signal processing of the LP-WUS is performed to reliably obtain determine that the signal is intended for the device and the signal is a wake-up signal. Application processor 212 may trigger baseband processor 210 to wake-up MR 208. Based on the processing of LP-WUS 202 by baseband processor 210 and application processor 212, MR 208 is triggered to wake-up or turn on MR 208. MR 208 may then transmit and receive main radio signal 204. For example, a WTRU may have MR 208 turned off to reduce power consumption. Upon receiving LP-WUS 202, LR 206 may trigger MR 208 to wake-up and start monitoring a channel of a wireless network. For example, MR 208 may start to monitor a physical downlink control signal (PDCCH), listen for paging occasion, and transition from an idle or inactive mode to an active mode.

In 3GPP Rel-19 , it has been agreed that a WTRU would be configured with entry/exit conditions for LP-WUS monitoring in IDLE/INACTIVE mode. The WTRU may start LP-WUS monitoring if the serving cell measurement performed by the MR is above entry threshold(s), if configured by the gNB.

If WTRU starts LP-WUS monitoring, it may stop the legacy paging occasion (PO) monitoring before the WTRU receives LP-WUS indicating wake-up. The WTRU monitors the legacy PO (and may monitor paging early indication (PEI)) and may stop LP-WUS monitoring if the serving cell measurement performed by the LR is below exit threshold(s), if configured by the gNB.

Current 3 GPP Rel.19 LP-WUS monitoring entry/exit conditions at least for IDLE/INACTIVE are based on MR measurements (and potentially LR measurement) of signals from the network.

One problem is that a WTRU may sometimes still be under MR coverage, but the WTRU does not activate the LR-based monitoring (e.g., due to reaching the exit conditions and switching back to regular monitoring) to avoid coverage issues and therefore cannot benefit from the full energy saving possibility, for example at the cell-edges or for higher-frequency cells with reduced coverage.

For example, the LP-WUS and MR coverage areas may be different (e.g., due to signal design, configuration or propagation). In addition, the exit condition threshold is likely to be more conservative than the MR threshold to avoid losing cell coverage while monitoring LP-WUS, to ensure reliability of the LP-WUS reception, and to avoid any mismatch between a LR and MR measurements and coverage.

A WTRU may be capable of relaying a LP-WUS to another WTRU if the relay WTRU is in coverage and the remote WTRU can benefit from extended LP-WUS coverage.

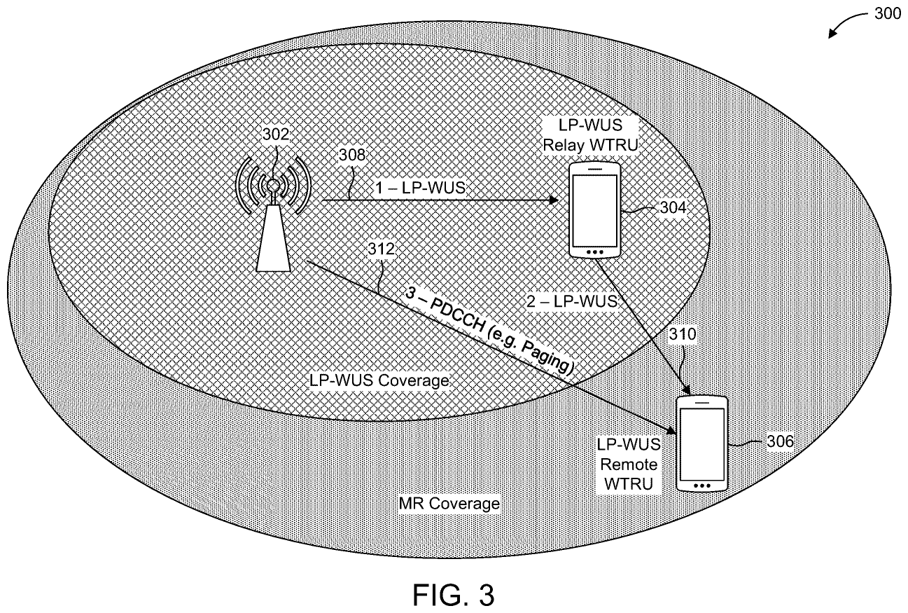

FIG. 3 illustrates an example WTRU relay implementation for extending LP-WUS coverage. As illustrated in FIG. 3, WTRU 304 may be in MR coverage and LP-WUS coverage of gNB 302, and WTRU 306 may be in MR coverage of gNB 302, but not LP-WUS coverage of gNB 302. In this case, WTRU 310 may not take advantage of the energy efficiency provided by the low-power radio. WTRU 304 may listen for and receive LP-WUS 308 addressed to WTRU 310. WTRU 304 may relay LP-WUS 308 to WTRU 306 allowing WTRU 306 to wake-up and receive paging signal 312 from gNB 302. This allows WTRU 310 to benefit from the energy efficiency of the low-power radio that may be otherwise unavailable.

A WTRU may be configured with one or more remote WTRU(s) monitoring resources and forwarding resources, for example, remote-specific timings/power configuration. When activated to monitor another WTRU's LO, the WTRU may check activation criterion to ensure coverage, and then monitors the LO of the remote WTRUs. When the WTRU receives a LO targeting a remote WTRU, the WTRU determines the transmit resource and configuration specific to the remote, e.g. based on timing and received configuration.

A relay WTRU may send LP-WUS forwarding capability information including, for example, LP-WUS transmit power, LO forwarding min delay, max. number of LO monitoring etc. The relay WTRU may receive, in response, a configuration from the network for LP-WUS coverage extension, the configuration may include: a configuration to monitor the LP-WUS of the remote WTRU including LO/MO resource occasions and configuration of the remote WTRU and ID/subgroups; a configuration for LP-WUS transmission/forwarding for remote WTRU(s), for example, Min/Max delay between reception of LP-WUS and forwarding of the LP-WUS to the remote; a configuration for LP-WUS forwarding transmissions and LP-SS transmissions, for each remote WTRU, for example: LP-WUS format (OFDM, OOK) and content (target ID/subgroup), Semi-Persistent resources on UL; and conditions for relaying, for example Activation/Deactivation criteria, e.g., based on MR/LR thresholds.

The relay WTRU may receive an indication to start monitoring remote WTRUs'LP-WUS. The indication to start monitoring may, for example, be an RRC/MAC/DCI indicating the remote WTRU(s) to forward to, an indication activating the SP resource for forwarding, or an indication may include a remote WTRU specific: timing alignment, transmit power indication.

The relay WTRU may monitor the LP-WUS using the remote WTRU(s) configuration and transmit the LP-SS on configured resources. If the WTRU detects/measures that a deactivation criterion is met, for example based on LR measurements, it may send a report to the network to stop monitoring the LP-WUS.

The relay WTRU may receive the LP-WUS targeting the remote WTRU, for example based on subgroup/UE ID, and determine the UL resource to transmit the LP-WUS, based on the received LP-WUS resource/timing and a mapping between the LP-WUS reception and forwarding, for example the next LP-WUS resource available after the reception of LP-WUS+configured delay.

The relay WTRU may transmit the LP-WUS to the specific remote WTRU using the determined UL resource, and remote WTRU specific timing and power. In a case where no specific timing is configured (or is too old), it may reset timing to 0. In this way, it is possible to extend coverage of LP-WUS and enable an extended battery life of remote WTRUs in cell-edges by allowing the remote WTRUs to stay in LP-WUS monitoring mode while located at the cell edge.

This may be useful in scenarios where a set of XR devices, a set of personal devices belonging to the same user or a set of industrial devices and where some devices may be more capable than others (e.g. for processing, coverage, battery) and one WTRU is willing to trade-off its battery/processing power (relay) to save another WTRUs (remote) battery/processing power.

A WTRU may use Discontinuous Reception (DRX) in RRC_IDLE and RRC_INACTIVE state in order to reduce power consumption. The WTRU may monitor one paging occasion (PO) per DRX cycle. A PO is a set of PDCCH monitoring occasions and can consist of multiple time slots (e.g. subframe or OFDM symbol) where paging DCI can be sent. One Paging Frame (PF) is one Radio Frame and may contain one or multiple PO(s) or starting point of a PO.

In multi-beam operations, a WTRU assumes that the same paging message and the same Short Message are repeated in all transmitted beams and thus the selection of the beam(s) for the reception of the paging message and Short Message is up to WTRU implementation. The paging message is same for both RAN initiated paging and CN initiated paging.

The WTRU may initiate RRC Connection Resume procedure upon receiving RAN initiated paging. If the WTRU receives a CN initiated paging in RRC_INACTIVE state, the WTRU moves to RRC_IDLE and informs NAS.

When SearchSpaceId other than 0 is configured for pagingSearchSpace, the WTRU monitors the (i_s+1)th PO. A PO is a set of ‘S*X ’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is otherwise equal to 1. The [x*S+K]th PDCCH monitoring occasion for paging in the PO corresponds to the Kth transmitted SSB, where x=0, 1, . . . , X-1 and K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter; otherwise it is equal to i_s*S*X. If X>1, when the WTRU detects a PDCCH transmission addressed to P-RNTI within its PO, the WTRU is not required to monitor the subsequent PDCCH monitoring occasions for this PO.

The following parameters are used for the calculation of PF and i_s above:
T: DRX cycle of the WTRU (T is determined by the shortest of the WTRU specific DRX value(s), if configured by RRC and/or upper layers, and a default DRX value broadcast in system information. In RRC_IDLE state, if WTRU specific DRX is not configured by upper layers, the default value is applied);
N: number of total paging frames in T;
Ns: number of paging occasions for a PF;
PF_offset: offset used for PF determination; and
UE_ID: 5G-S-TMSI mod 1024.

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter first-PDCCH-MonitoringOccasionOfPO is signaled in SIB1 for paging in initial DL BWP. For paging in a DL BWP other than the initial DL BWP, the parameter first-PDCCH-MonitoringOccasionOfPO is signaled in the corresponding BWP configuration.

If the WTRU has no 5G-S-TMSI, for instance when the WTRU has not yet registered onto the network, the WTRU may use as default identity UE_ID=0 in the PF and i_s formulas above.

A WTRU may monitor for or listen to the paging message to know about one or more of incoming calls, system information change, ETWS (Earthquake and Tsunami Warning Service) notification for ETWS capable WTRUs, CMAS (Commercial Mobile Alert System) notification and Extended Access Barring parameters modification.

In RRC Idle state, the WTRU monitors Short Messages transmitted with paging RNTI (P-RNTI) over DCI and monitors a Paging channel for CN paging using 5G-S-TMSI. In RRC Inactive state, the WTRU monitors Short Messages transmitted with P-RNTI over DCI and monitors a Paging channel for CN paging using 5G-S-TMSI and RAN paging using fullI-RNTI. In an RRC Connected state, a WTRU may monitor Short Messages transmitted with P-RNTI over DCI.

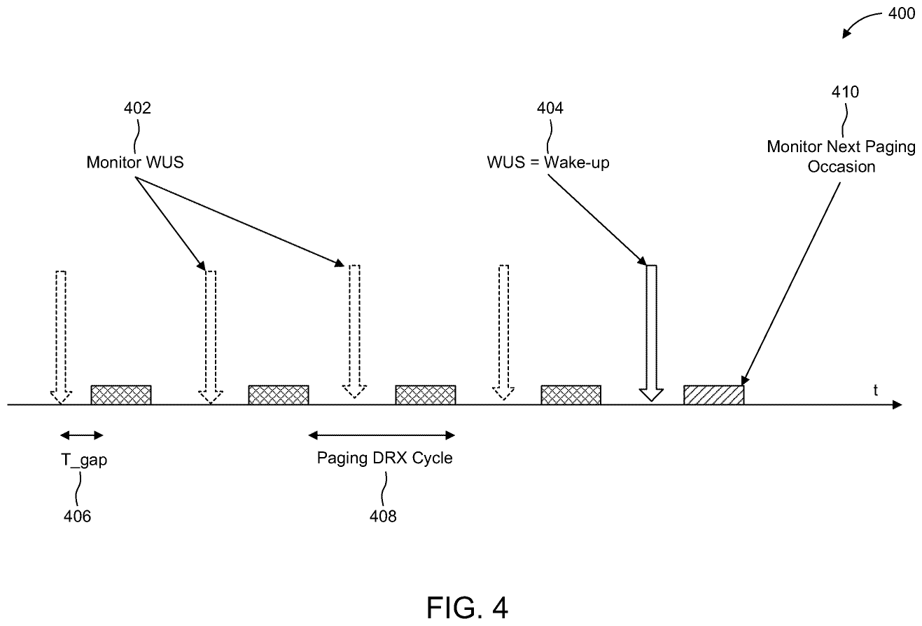

FIG. 4 illustrates of an example idle mode wake-up signal monitoring in 3GPP Rel-15 .

In 3GPP Rel-15 , a wake-up signal for Idle mode paging was introduced for WTRUs supporting NB-IoT or eMTC. Similar to the concept described above for connected mode, the WTRU monitors for a wake-up signal 402 at a time specified by T_gap 406 before the paging occasion 410. If the WTRU receives an indication that there may be paging addressed to that WTRU in the next paging time window then the WTRU monitors PDCCH during each paging occasion of that paging time window. The paging time window is defined such that WTRUs with a very long DRX 408 in the order of minutes (eDRX) and which may suffer from clock drift compared to the network timing may reliably receive paging. The WTRU will wake-up upon receiving wake-up signal 404.

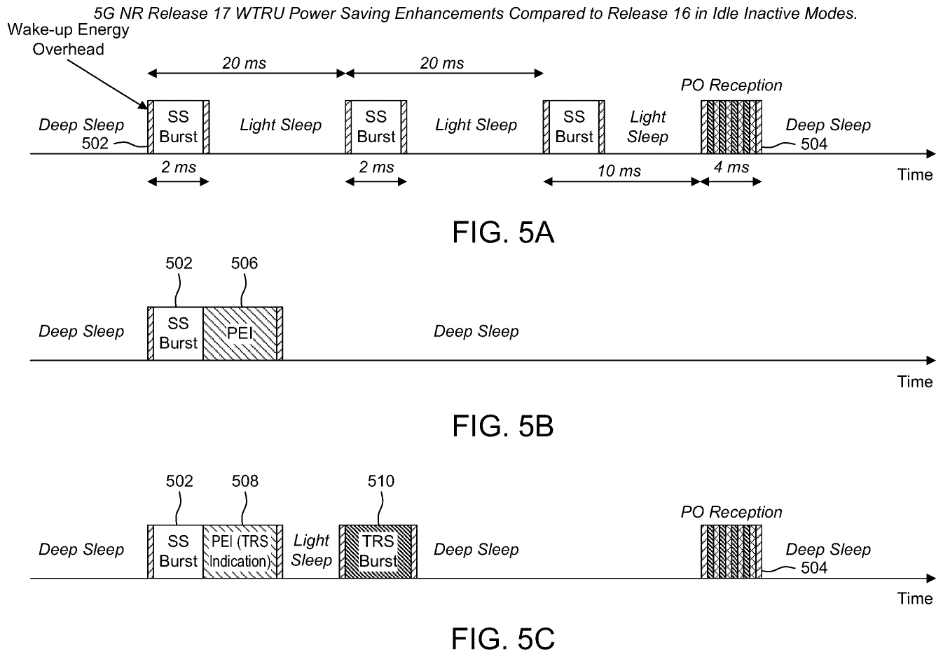

FIG. 5A illustrates WTRU power consumption in 3GPP Rel-16.

In 3GPP Rel-16 , the WTRU had to wake-up to measure SS burst 502 for time/frequency synchronization and monitor paging occasions (POs) 504, however, in Rel-17, the WTRU can maintain deep sleep if the WTRU does not receive PEI. In addition, if the WTRU receives PEI, the WTRU can wake up, measure a TRS burst and receive POs. Another benefit of PEI is that the WTRU does not need to periodically wake up to maintain time/frequency synchronization for PO reception as PEI is able to indicate a TRS burst for acquiring time/frequency synchronization.

FIG. 5B illustrates WTRU power consumption in 3GPP Rel-17 using PEI.

In 3GPP Rel-17, a wake-up signal for Idle mode paging was discussed. A paging early indication (PEI) 506 in DCI format 2-7 transmitted prior to the WTRU paging occasion will indicate whether the WTRU has to monitor PDCCH and potentially PDSCH to receive a paging message.

FIG. 5C illustrates WTRU power consumption in 3 GPP Rel-17 using PEI and TRS.

PEI also includes paging indication which indicates WTRU subgroups in one or more paging occasions to be used for paging and tracking reference signal (TRS) availability indication for acquiring time/frequency synchronization for paging. As illustrated in FIG. 5C, SS Burst 502 is followed by PEI with TRS indication 508. TRS 510 helps the WTRU synchronize with the network.

As used herein, LP-WUS occasion (LO) may be interchangeably used with LP-WUS monitoring occasion (MO), and still consistent with this description. In an embodiment, a WTRU may receive one or more configuration/information. The configuration/information may be delivered via one or more of SIB (e.g., SIB1), RRC and MAC CE. The one or more of configuration/information may be one or more of the following: UE ID, paging related configurations, PEI related configurations, configurations for LP-WUS, and Subgroup ID.

UE ID, in an embodiment, the WTRU may receive UE ID. For example, 5G-S-TMSI mod 1024 may be used as a UE ID. Paging related configurations may include: nAndPagingFrameOffset, in an embodiment, the WTRU may receive information nAndPagingFrameOffset. Based on the received information, the WTRU may determine one or more of the following information; Number of total paging frames (N), in a solution, the WTRU may receive/determine the information on number of total paging frames (N) (e.g., via nAndPagingFrameOffset). Candidate values for the number of total paging frames may be different for different serving cell SSB periodicity, Paging frame offset (PF_offset), in a solution, the WTRU may receive/determine the information on paging frame offset (e.g., via nAndPagingFrameOffset).

DRX cycle (T), in an embodiment, the WTRU may receive information of DRX cycle of the WTRU (T is determined by the shortest of the WTRU specific DRX value(s), if configured by RRC and/or upper layers, and a default DRX value broadcast in system information. in an embodiment, the WTRU may use a default value (e.g., In RRC_IDLE state, if WTRU specific DRX is not configured by upper layers, the default value is applied).

Number of paging occasions (e.g., for a PF) (Ns), in an embodiment, the WTRU may receive information of number of paging occasions (e.g., per PF) for paging operation. For example, the WTRU may receive one of 1, 2 or 4 paging occasions for paging operation.

PEI related configurations may include:
Search space set (e.g., by pei-SearchSpace), in a solution, the WTRU may receive information of one or more search space sets (e.g., to monitor PDCCH for detection of DCI format 2_7 according to a Type2A-PDCCH CSS set);
Number of paging occasions in PEI (e.g., N_PO\hat{ }PEI), in an embodiment, the WTRU may receive information of number of paging occasions supported by PEI. For example, one of 1, 2, 4 or 8 may be indicated;
PEI payload size (e.g., by payloadSizeDCI-2-7), in an embodiment, the WTRU may receive information of PEI payload size. For example, up to 41 bits and 43 bits for licensed and unlicensed spectrums, respectively, may be indicated;
PEI frame offset (e.g., by pei-FrameOffset), in an embodiment, the WTRU may receive frame offset for PEI. For example, the WTRU may receive offset from the start of a reference frame for PEI-O (e.g., the start of a frame) to the start of a first paging frame of the paging frames associated with a number of PDCCH monitoring occasions for DCI format 2_7;
PEI symbol offset (e.g., for PEI by firstPDCCH-MonitoringOccasionOfPEI-O), in an embodiment, the WTRU may receive symbol offset for PEI. For example, the WTRU may receive offset (e.g., in number of symbols) from the start of the frame to the start of the first PDCCH monitoring occasion for DCI format 2_7; and
Number of subgroups (e.g., N _SG\hat{ }PO for PEI), in an embodiment, the WTRU may receive information of total number of subgroups (e.g., for PEI). For example, the WTRU may receive one or both of subgroupsNumPerPO and subgroupsNumForUEID. Based on the received information, the WTRU may determine whether to use UE ID based subgrouping or CN based subgrouping. For example, one or more of the following may be used. In an example, if subgroupsNumForUEID is absent in subgroupConfig, the subgroup ID based on CN assigned subgrouping, if available for the WTRU, may be used. In another example, if both subgroupsNumPerPO and subgroupsNumForUEID are configured, and subgroupsNumForUEID has the same value as subgroupsNumPerPO, the subgroup ID based on UE_ID based subgrouping may be used in the cell. In another example, if both subgroupsNumPerPO and subgroupsNumForUEID are configured, and subgroupsNumForUEID<subgroupsNumPerPO: the subgroup ID based on CN assigned subgrouping, if available for the WTRU, may be used in the cell; otherwise, the subgroup ID based on UE_ID based subgrouping may be used in the cell; and if the WTRU has no CN assigned subgroup ID or does not support CN assigned subgrouping, and there is no configuration for subgroupsNumForUEID, the WTRU may monitors the associated PO.

Configurations for LP-WUS may include: LP-WUS occasions (LOs) and LP-WUS monitoring occasions (MOs), Number of subgroups, size of LP_WUS information, LP-WUS frame offset, and LP_WUS symbol offset.

LP-WUS occasions (LOs) and LP-WUS monitoring occasions (MOs), in an embodiment, the WTRU may receive configurations of LOs. For example, based on the configurations of LOs, the WTRU may receive configurations of N*K MOs (e.g., by receiving N*K sets of resources) for each LO where N may be a number of beams corresponding to LP-WUS and K may be a number of LP-WUS MOs for each beam. The configuration of LOs (e.g., each LO) and/or MOs (e.g., each MO) may be based on one or more of the following: one or more of a sequence ID, a scrambling ID and cell ID, signal structure, waveform, monitoring type, frequency resources, time resources, and the one or more reference resources may be one or more of the start of the frame, an associated paging frame, an associated paging occasion, one or more associated LOs (e.g., for MOs), an associated PEI search space, SSB (PSS or SSS in NR-SS), LP-SS and etc.

One or more of a sequence ID, a scrambling ID and cell ID, in a solution, the WTRU may receive a configuration of one or more of sequence ID, a scrambling ID and cell ID. For example, the WTRU may receive a LP-WUS in the LP-WUS resource by using a sequence which is generated by using the ID and/or data which is scrambled by using the ID (e.g., in time and/or frequency domain); In an embodiment, the WTRU may receive a configuration of signal structure. For example, the WTRU may receive one of support of preamble, preamble length (if configured), message type (e.g., sequence and/or encoded data), number of repetition and etc. In an embodiment, the WTRU may receive a configuration of waveform. For example, the WTRU may receive one of OOK-1, OOK-4, OFDMA or etc. as a waveform of LP-WUS. For OOK-4, M can be additionally configured. In an embodiment, the WTRU may receive a configuration of monitoring type. For example, the WTRU may receive one of continuous monitoring and duty-cycled monitoring. In an embodiment, the WTRU may receive a configuration of absolute frequency resources. For example, the WTRU may receive a configuration based on one or more of RBs, sub-bands, BWPs and etc. to indicate frequency resources for receiving LP-WUS. In an embodiment, the WTRU may receive a configuration of relative time resources. For example, the WTRU may receive frequency offset (e.g., in RBs/sub-bands/RBGs) from one or more reference resources. In an embodiment, the WTRU may receive a configuration of absolute time resources. For example, the WTRU may receive a configuration based on one or more of periodicity, offsets and etc. The indication of configuration may be based on OFDM symbols, us, slots and etc.

In an embodiment, the WTRU may receive an implicit configuration of time resources. For example, the WTRU may receive time offset (e.g., in symbols/subframes/frames) from one or more reference resources. The one or more reference resources may be one or more of the start of the frame, an associated paging frame, an associated paging occasion, one or more associated LOs (e.g., for MOs), an associated PEI search space, SSB (PSS or SSS in NR-SS), LP-SS and etc.

In an embodiment, the WTRU may receive information of number of subgroups for LP-WUS. In an example, the number of subgroups may be total number of subgroups for LP-WUS operation. In another example, the number of subgroups may be a number of subgroups supported by each LO or MO. In another embodiment, the WTRU may determine number of subgroups based on the received information. For example, the WTRU may use the number of subgroups for PEI as the number of subgroups for LP-WUS. In another example, the WTRU may determine the number of subgroups for LP-WUS as a scaling factor*the number of subgroups for PEI. The scaling factor may be indicated via one or more of SIB, RRC and MAC CE.

In an embodiment, the WTRU may receive information of LP-WUS payload size. For example, up to 8, 16 or 24 bits may be indicated. The WTRU may receive size of LP-WUS information for each information type. For example, the WTRU may receive a first size of LP-WUS information for a first information type (e.g., for one or more of TRS availability indication, SI change, ETWS/CMAS information and etc.). The WTRU may receive a second size of LP-WUS information for a second information type (e.g., subgroup indication).

In an embodiment, the WTRU may receive frame offset for LP-WUS. For example, the WTRU may receive offset from the start of a reference frame for LP-WUS (e.g., the start of a frame) to the start of a first paging frame of the paging frames associated with LP-WUS monitoring for the WTRU.

In an embodiment, the WTRU may receive symbol offset for LP-WUS. For example, the WTRU may receive offset (e.g., in number of symbols) from the start of the frame to the start of the first LP-WUS monitoring occasion (e.g., for monitoring LP-WUS).

In an embodiment, the WTRU may receive subgroup ID (e.g., for PEI and/or LP-WUS). For example, the WTRU may receive subgroup ID(s) from AMF via NAS signaling (e.g., in CN based subgrouping). In another example, the WTRU may determine the subgroup ID based on the UE ID and the total number of subgroups for UE ID based subgrouping. In an example, the WTRU may receive a subgroup ID for both PEI and LP-WUS). In another example, the WTRU may receive a first subgroup ID for PEI and a second subgroup ID for LP-WUS. In another example, the WTRU may receive a subgroup ID for PEI and determine a subgroup ID for LP-WUS based on the received information. In another example, the WTRU may determine subgroup IDs for PEI and LP-WUS, respectively, based on the received information (e.g., UE ID).

Although this description focuses on a 5G NR LP-WUS design, it is understood that similar solutions may apply to other Wake-up signals format and procedures, e.g., for 6G and/or any signal associated to a WTRU (e.g. via an ID—directly or indirectly) intending for the WTRU to wake-up a radio and/or to restore a more active monitoring performed on a radio.

In an embodiment, the WTRU may determine one or more associated POs with the WTRU. For example, the WTRU may determine one or more associated POs based on the UE ID. In an example, the WTRU may determine PO ID based on i_s: floor (UE_ID/N) mod Ns. In another example, i_PO=((UE_IDmodN)·N_S+i_s) mod N_PO\hat{ }PEI may be used.

In an embodiment, the WTRU may determine one or more LOs associated with the WTRU. The WTRU may determine the one or more LOs based on one or more of the following: UE ID, associated PO, and associated PF.

For example, the WTRU may determine the one or more LOs based on the UE ID. For example, an associated LO ID may be floor (UE_ID/N) mod N_LO wherein N_LO may be total number of LOs (e.g., for a PF).

Based on the determined POs, the WTRU may determine one or more LOs. For example, a LO may be associated with each PO (e.g., based on time and/or frequency offset). The WTRU may determine a LO which is associated with the determined PO (e.g., based on the UE ID).

For example, the WTRU may determine one or more associated PFs based on the UE ID. Based on the determined PFs, the WTRU may determine one or more LOs. For example, a LO may be associated with each PF (e.g., based on time and/or frequency offset). The WTRU may determine a LO which is associated with the determined PF (e.g., based on the UE ID).

In an embodiment, the WTRU may determine one or more MOs associated the WTRU. The WTRU may determine the one or more MOs based on one or more of the following: UE ID, Associated PO, Associated LO, and Associated PF.

For example, the WTRU may determine the one or more LOs based on the UE ID. Based on the determined PO, the WTRU may determine one or more MOs. For example, one or more MOs may be associated with each PO (e.g., based on time and/or frequency offset). The WTRU may determine one or more MOs which is associated with the determined PO (e.g., based on the UE ID). Based on the determined LO, the WTRU may determine one or more MOs. For example, a LO may be associated with each PO (e.g., based on time and/or frequency offset). The WTRU may determine one or more MOs which is associated with the determined PO (e.g., based on the UE ID). For example, the WTRU may determine one or more associated PFs based on the UE ID. Based on the determined PFs, the WTRU may determine one or more LOs. For example, a LO may be associated with each PF (e.g., based on time and/or frequency offset). The WTRU may determine a LO which is associated with the determined PF (e.g., based on the UE ID).

In an embodiment, the WTRU may determine LP-WUS information based on the received information. For example, the WTRU may determine whether to split the subgroup information into two or more LOs and/or MOs. For example, the WTRU may determine whether to split the subgroup information based on the size of LP-WUS information. For example, the WTRU may determine the number of subgroups based on the size of LP-WUS information (e.g., for subgroups) and the number of subgroups for LP-WUS. For example, if the size of LP-WUS information (e.g., for all LP-WUS or all subgroup information)>=required size of information for all subgroups (e.g., the number of all subgroups (e.g., for LP-WUS) if bitmap is used), the WTRU may receive information of all subgroups within one associated LO or MO of the LP-WUS with the WTRU. If the size of LP-WUS information (e.g., for all LP-WUS or all subgroup information)<required size of information for all subgroups (e.g., the number of subgroups (e.g., for LP-WUS) if bitmap is used), the WTRU may receive information of all subgroups within two or more associated LOs or MOs.

Based on the determination, the WTRU may split the subgroup information into two or more LOs and/or MOs. The split of the subgroup information may be based on one or more of the following: Number of subgroups for each LO or MO. For example, the WTRU may receive a number of subgroups for each LO or MO (e.g., via one or more of SIB, RRC and MAC CE). Based on the number of subgroups, the WTRU may determine LOs or MOs indicating a set of subgroups, for example, if 8 subgroup is supported and 4 subgroups for each MO is indicated, then first 4 subgroup information may be indicated in a first MO and second 4 subgroup information may be indicated in a second MO; number of associated LOs/MOs, for example, the WTRU may determine a number of subgroups for each LO or MO based on the number of associated LOs (e.g., per PO or paging frame e.g., within a same beam) or POs (e.g., per LO, PO or paging frame e.g., within a same beam). The WTRU may receive S subgroups in each MO wherein S may be total number of subgroups/K (number of MOs within a LO with a same beam); and based on a number of subgroups for PEI, for example, the WTRU may receive a total number of subgroups for PEI (e.g., via one or more of SIB, RRC and MAC CE). For example, the WTRU may receive indication of the total number of subgroups for PEI in each LO or MO. For example, if 8 subgroups are configured for PEI and 16 subgroups are configured for LP-WUS, then a first MO may indicate a first 8 subgroup and a second MO may indicate a second 8 subgroup.

In an embodiment, the WTRU may determine a subgroup ID of the WTRU for LP-WUS. The determination may be based on one or more of the following: identical subgroup ID with PEI, indicated subgroup ID for LP-WUS, and determined subgroup ID for LP-WUS.

In a solution, the WTRU may use a same subgroup ID used for PEI. The same subgroup ID may be used if number of subgroups for LP-WUS is same with number of subgroups for PEI (e.g., if number of subgroup in LP-WUS=number of subgroup in PEI). In an embodiment, the WTRU may receive an indication of a subgroup ID for LP-WUS (e.g., via one or more of NAS signaling from AMF, SIB, RRC and MAC CE). In an embodiment, the WTRU may determine a subgroup ID for LP-WUS. For example, the WTRU may determine a WTRU subgroup ID for LP-WUS based on the WTRU subgroup ID for PEI. For example, e.g., if number of subgroup in LP-WUS>number of subgroup in PEI, WTRU subgroup ID in LP-WUS may be WTRU subgroup ID in PEI*Number of subgroup in LP-WUS/number of subgroup in PEI (or indicated scaling factor)+mod(UE_ID, Number of subgroup in LP-WUS/number of subgroup in PEI (or indicated scaling factor)). In another example, e.g., if number of subgroup in LP-WUS<number of subgroup in PEI, WTRU subgroup ID in LP-WUS may be floor (WTRU subgroup ID/Number of subgroup in LP-WUS*number of subgroup in PEI).

In an embodiment, the WTRU may determine LOs and MOs to monitor LP-WUS. The MOs and LOs to be monitored may be one or more of the following. For example, the WTRU may monitor all LOs/MOs associated with the WTRU (e.g., based on UE ID and the associated PO). For example, the WTRU may monitor LOs/MOs associated with the WTRU's subgroup ID (e.g., among the LOs/MOs associated with the UE ID and the associated PO). For example, the WTRU may only monitor LOs/MOs which indicates the determined WTRU's subgroup ID. For example, the WTRU monitors LOs/MOs delivering common information. For example, the WTRU may monitor LOs/MOs delivering TRS availability information, SI change, ETWS/CMAS information and etc.

In an embodiment, a WTRU may be configured with one or more LP-WUS monitoring configurations. For example, a monitoring type (e.g., continuous or duty cycled), a monitoring window (periodicity and/or offset), LP-WUS bandwidth, Low Power Synchronization Signal (LP-SS) configuration and etc. may be configured. If the WTRU receives/detects one or more LP-WUSs, the WTRU may apply one or more of the following procedures after receiving/detecting one or more LP-WUSs.

In an embodiment, the WTRU may wake up (e.g., activate main radio (MR) and/or deactivate low power wake-up receiver (LP-WUR)) and start monitoring of PDCCH (e.g., for paging). In an embodiment, the WTRU may apply update of SI based on the received LP-WUS. In an example, the WTRU may apply one or more indicated sets of SI (e.g., by LP-WUS) after receiving the one or more LP-WUSs. In another example, the WTRU may receive updated SI (e.g., via LP-WUSs and/or PDSCHs after activating MR). In an embodiment, the WTRU may apply update of paging related information based on the received LP-WUS. In an example, the WTRU may apply one or more indicated sets of paging related information (e.g., by LP-WUS) after receiving the one or more LP-WUSs. In another example, the WTRU may receive updated paging related information (e.g., via LP-WUSs and/or PDSCHs after activating MR). If the WTRU does not receive/detect one or more LP-WUSs, the WTRU may continue monitoring LP-WUS based on the one or more LP-WUS monitoring configurations.

A WTRU may use a (e.g., separate) low power-wake up receiver (LP-WUR) which can monitor low-power wake-up signals (LP-WUS) and trigger and/or wake-up the Main radio Receiver (MR) dedicated for data and control signal transmission and/or reception. The WTRU may be configured with one or more modes of operation, for example in systems based on LP-WUS. In an example, the WTRU may be configured with MR-ON mode and MR-OFF mode. The WTRU may alternate and/or switch between operating in an MR-ON mode and an MR-OFF mode. In an example, the WTRU may save power being in MR-OFF mode. In another example, the WTRU may enter MR-ON mode upon receiving an LP-WUS.

The WTRU may determine to switch from MR-ON to MR-OFF when some conditions (“entry conditions”) are satisfied. For example, the WTRU may receive from the network a configuration (e.g., from SIB or RRC), including measurement on the MR (e.g., based on SSB or CSI-RS measurements) being above a threshold. The WTRU may receive from the network a configuration (e.g., from SIB or RRC), including measurement on the LR (e.g., based on LP-SS or LP-WUS measurements) being above a threshold. The WTRU may be preconfigured with conditions, e.g., based on implementations. When the (pre)configured conditions are satisfied, the WTRU may switch from MR-ON to MR-OFF.

The WTRU may determine to switch from MR-OFF to MR-ON when some conditions (“exit conditions”) are satisfied. For example, the WTRU may receive from the network a configuration (e.g., from SIB or RRC), including measurement on the LR (e.g., based on LP-SS or LP-WUS measurements) being below a threshold. The WTRU may be preconfigured with conditions, e.g., based on implementations. When the (pre)configured conditions are satisfied, the WTRU may switch from MR-OFF to MR-ON.

The WTRU in MR-ON mode may turn on the MR and use the MR to send and/or receive channels, signals, etc., for example to and/or from a Node-B. The WTRU in MR-ON mode may monitor, detect, receive and/or measure one or more reference signals, for example SSB, CSI-RS, PT-RS, DR-RS, etc.

The WTRU in MR-OFF mode may turn off the MR and may use the LP-WUR to receive one or more low-power signals, channels, etc. For example, the WTRU in MR-OFF mode may monitor, detect, receive and/or measure one or more Low-Power Synchronization Signaling (LP-SS) and/or LP-WUS. During MR-OFF mode, the WTRU may monitor to receive and/or detect one or more configured LP-WUS and may wake up MR and switch to MR-ON mode upon reception of at least one LP-WUS.

The WTRU in MR-OFF mode, for example, may use LP-WUR to monitor the LP-SS signal to obtain necessary synchronization. In an example, a WTRU in RRC-Idle and/or RRC-Inactive states in MR-OFF mode may need to switch to MR-ON mode and to wake up MR after receiving and/or detecting LP-WUS. After waking up the MR and switching to MR-ON mode, the WTRU may monitor one or more paging occasions (PO), for example to receive paging messages. After receiving the paging message and based on the received paging message, the WTRU may switch to RRC-Connected state, transmit, and/or receive one or more indicated signals and/or channels, and so forth. After transmitting and/or receiving the indicated signals and/or channels, the WTRU may turn off the MR and switch back to MR-OFF mode. In another example, a WTRU in RRC-Connected state in MR-OFF mode may need to switch to MR-ON mode and to wake up MR after receiving and/or detecting LP-WUS. After waking up the MR and switching to MR-ON mode, the WTRU may monitor to receive PDCCH in one or more configured CORESETs (control channel resource sets) and/or CSS (common search space). The received PDCCH may include grant indications for one or more UL and/or DL transmissions and/or receptions. In another example, the WTRU in MR-ON mode may be configured to transmit on or more CSI reports. After transmitting and/or receiving based on the configurations and/or indicated grant indication, the WTRU may turn off the MR and switch back to MR-OFF mode.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following: CSI Report Configuration, including one or more of the following: CSI report quantity, e.g., Channel Quality Indicator (CQI), Rank Indicator (RI), Precoding Matrix Indicator (PMI), CSI-RS Resource Indicator (CRI), Layer Indicator (LI), etc., CSI report type, e.g., aperiodic, semi persistent, periodic, CSI report codebook configuration, e.g., Type I, Type II, Type II port selection, etc., and CSI report frequency; CSI-RS Resource Set, including one or more of the following CSI Resource settings: NZP-CSI-RS Resource for channel measurement, NZP-CSI-RS Resource for interference measurement, and CSI-IM Resource for interference measurement; and NZP CSI-RS Resources, including one or more of the following: NZP CSI-RS Resource ID, periodicity and offset, QCL Info and TCI-state, and resource mapping, e.g., number of ports, density, CDM type, etc.

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included, and other parameters may be included.

Synchronization Signal (SS) reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

Synchronization Signal (SS) signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth)

Sounding reference signals RSRP (SRS-RSRP) may be measured based on the linear average over the power contribution of the resource elements (RE) that carry the respective SRS.

Secondary synchronization signal reference signal received quality (SS-RSRQ) may be measured based on measurements on the reference signal received power (SS-RSRP) and received signal strength (RSSI). In an example, the SS-RSRQ may be calculated as the ratio of N×SS-RSRP/NR carrier RSSI, where N may be determined based on the number of resource blocks that are in the corresponding NR carrier RSSI measurement bandwidth. As such, the measurements to be used in the numerator and denominator may be over the same set of resource blocks.

CSI reference signal received quality (CSI-RSRQ) may be measured based on measurements on the reference signal received power (CSI-RSRP) and received signal strength (RSSI). In an example, the SS-RSRQ may be calculated as the ratio of N×CSI-RSRP/CSIRSSI, where N may be determined based on the number of resource blocks that are in the corresponding CSI-RSSI measurement bandwidth. As such, the measurements to be used in the numerator and denominator may be over the same set of resource blocks.

A CSI-RS Resource Set (e.g., NZP-CSI-RS-ResourceSet) may include one or more of CSI-RS resources (e.g., NZP-CSI-RS-Resource and CSI-ResourceConfig), wherein a WTRU may be configured with one or more of the following in a CSI-RS Resource: CSI-RS periodicity and slot offset for periodic and semi-persistent CSI-RS Resources; CSI-RS resource mapping to define the number of CSI-RS ports, density, CDM-type, OFDM symbol, and subcarrier occupancy; the bandwidth part to which the configured CSI-RS is allocated; and the reference to the TCI-State including the QCL source RS(s) and the corresponding QCL type(s).

One or more of following configurations may be used for RS resource set: a WTRU may be configured with one or more RS resource sets, the RS resource set configuration may include one or more of following: RS resource set ID; one or more RS resources for the RS resource set; repetition (i.e., on or off); aperiodic triggering offset (e.g., one of 0-6 slots); and TRS info (e.g., true or not).

One or more of following configurations may be used for RS resource: a WTRU may be configured with one or more RS resources; the RS resource configuration may include one or more of following: RS resource ID; resource mapping (e.g., REs in a PRB); power control offset (e.g., one value of −8, . . . , 15); power control offset with SS (e.g.,- 3 dB, 0 dB, 3 dB, 6 Db); scrambling ID; periodicity and offset; and QCL information (e.g., based on a TCI state).

In the following, a property of a grant or assignment may consist of at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and any parameter provided in a DCI, by MAC or by RRC for the scheduling the grant or assignment.

In the following, an indication by DCI may consist of at least one of the following: an explicit indication by a DCI field or by RNTI used to mask or scramble the CRC of the DCI, and an implicit indication by a property such as DCI format, DCI size, Coreset or search space, Aggregation Level, first resource element of the received DCI (e.g., index of first Control Channel Element), where the mapping between the property and the value may be signaled by RRC or MAC.

Receiving or monitoring for a DCI with or using an RNTI may mean that the CRC of the DCI is masked or scrambled with the RNTI.

As used herein, a signal may be interchangeably used with one or more of following: Sounding reference signal (SRS); channel state information-reference signal (CSI-RS); demodulation reference signal (DM-RS); phase tracking reference signal (PT-RS); and synchronization signal block (SSB), consistent with this description.

As used herein, a channel may be interchangeably used with one or more of following: physical downlink control channel (PDCCH); physical downlink shared channel (PDSCH); physical uplink control channel (PUCCH); physical uplink shared channel (PUSCH); physical random access channel (PRACH), and the like consistent with this description.

As used herein, a signal, channel, and message (e.g., as in DL or UL signal, channel, and message) may be used interchangeably, but still consistent with the description. Hereafter, RS may be interchangeably used with one or more of RS resource, RS resource set, RS port and RS port group, but still consistent with the description. As used herein, RS may be interchangeably used with one or more of SSB, CSI-RS, SRS, and DM-RS, TRS, PRS, and PTRS, but still consistent with the description. As used herein, time instance, slot, symbol, and subframe may be used interchangeably, but still consistent with the description. As used herein, the terms SSB, SS/PBCH block, PSS, SSS, PBCH, and MIB may be used interchangeably, and still consistent with the description. As used herein, the proposed solutions for beam resources prediction may be used for beam resources belonging to a single or multiple cells as well as single or multiple TRPs, and still consistent with the description. As used herein, CSI reporting may be interchangeably used with CSI measurement, beam reporting and beam measurement, but still consistent with the description. As used herein, a RS resource set may be interchangeably used with a beam group, but still consistent with the description.

In an embodiment, a WTRU may indicate its WTRU capability of supporting LP-WUS. The WTRU capability may indicate one or more of the following: supported signal structure type, supported waveform, low power synchronization signal (LP-SS), new radio synchronization signal (NR-SS), activation time, minimal preamble length, and support of timing cumulation during off state.

In an example, the WTRU may indicate supported signal structure types. For example, the WTRU may indicate a first signal structure type (e.g., a set of configurations including one or more of whether to support preamble, preamble length (if supported). In an example, the WTRU may indicate supported waveforms. For example, the WTRU may indicate one or more of OOK-1, OOK-2, OOK-3, OOK-4, FSK-1, FSK-2, OFDMA and etc.

In an example, the WTRU may indicate whether to support LP-SS and/or minimum configuration of LP-SS. For example, the WTRU may indicate required density, periodicity and etc. of LP-SS.

In an example, the WTRU may indicate whether to support NR-SS and/or minimum configuration of NR-SS. For example, the WTRU may indicate required density, periodicity and etc. of NR-SS. An activation time. In an example, the WTRU may indicate required activation time. The indication may be per signal structure type and/or supported waveform. For example, the WTRU may indicate activation time for each structure type and/or each waveform. In another example, the WTRU may indicate activation time between different structure types and/or different waveforms. For example, the WTRU may indicate first activation time for switching between same structure types/waveforms and second activation time(s) for switching between different structure types/waveforms.

In an example, the WTRU may indicate minimal preamble length. The indication may be per signal structure type and/or supported waveform. For example, the WTRU may indicate minimal preamble length for each structure type and/or each waveform.

In an example, the WTRU may indicate whether the WTRU support timing cumulation during its off state. Based on the indication, the WTRU may apply different timing and/or configurations. For example, the WTRU may apply a first activation time if the WTRU supports timing cumulation. If the WTRU apply a second activation time if the WTRU does not support timing cumulation.

In the following, a WTRU may be considered as a relay for LP-WUS (or for WUS in general) when the WTRU is configured to forward to another WTRU (a “remote WTRU”) a LP-WUS intended to the remote WTRU.

The Relay WTRU functionalities may include monitoring/receiving resources for another WTRU, i.e., using the configuration (resources, IDs) intended for the remote, detecting/identifying that the signal is intended to the other WTRU (e.g., by checking the UE ID or subgroup ID in the signal and/or based on the resource), prepare and transmit the signal to the remote WTRU e.g., as a copy of the original signal, or in another data, channel or format.

Note that in the following, the Relay WTRU does not necessarily require to be a SL Relay or have any other functionality beyond relaying the LP-WUS. The Remote WTRU does not necessarily require to be a SL Remote WTRU or have any other functionality beyond receiving LP-WUS from the Relay WTRU.

In the following, the Relay WTRU may be called “LP-WUS relay WTRU” ,“LP-Relay”, “Relay WTRU”, “UE-based LP-WUS transmitter” etc. interchangeably, and can be considered similarly as an assistant WTRU or a aggregated WTRU in cooperative communications or aggregated communications.

In the following, the Remote WTRU may be called “LP-WUS,” remoteWTRU,” “LP-Remote”, “Remote UE” etc. interchangeably, and can be considered similarly as an assisted WTRU or a aggregated WTRU in cooperative communications or aggregated communications.

The Relay and Remote WTRUs may communicate with each other using various communication systems and resources, for example but not limited, using UL resources, PC5/SL resources when PC5/SL connection is available, dedicated proprietary links/channels.

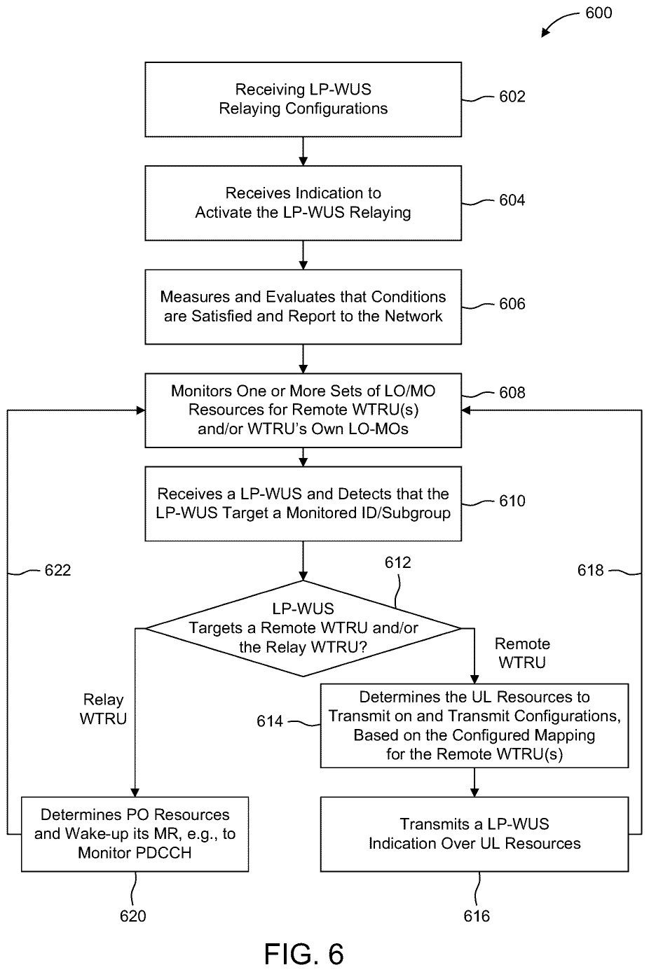

FIG. 6 is a flow diagram of an example LP-WUS coverage extension process 600.

At 602, a WTRU may receive LP-WUS configurations. For example, in an embodiment, a (relay) WTRU is configured to monitor LP-WUS occasions corresponding to another WTRU's occasions, e.g., using their resource. The WTRU may receive an indication to activate the relaying including timing or power indications and starts monitoring the resources of the other WTRU. Upon detection of a signal targeting the remote WTRU, e.g., based on identification, the WTRU may determine the resources to transmit the LP-WUS to the remote, based on received resource mapping configuration. The WTRU may also evaluates for signal quality or indications to determine whether to stop being a relay and report to the network accordingly.

In an embodiment, the WTRU may send its capabilities about LP-WUS monitoring to the network, e.g., using RRC or MAC indications. The network can then configure the WTRU to perform LP-WUS monitoring and/or relayed LP-WUS monitoring based on the capabilities. The capabilities may include, e.g., in addition with the previously mentioned capabilities: capability/Support of monitoring LP-WUS for other (remote) WTRUs, for example: the WTRU may indicate that it supports the monitoring of LP-WUS for other WTRU, and capable of transmitting LP-WUS signals; the WTRU may indicate how many remote WTRUs it can relay LP-WUS, and, e.g.; the LP signals it is capable of transmitting, e.g., OOK, FSK, OFDM-based etc. and max LP transmit power; the WTRU may indicate the capability of simultaneously monitoring its own LP-WUS and other WTRU's LP-WUS; the WTRU may indicate limitations such as being capable of relaying in RRC CONNECTED, IDLE or INACTIVE modes; and the WTRU may indicate over which resources/carriers/cells it is capable of transmitting LP-WUS, e.g., over UL resources and/or SL resources and/or over dedicated LP-WUS resources and/or resources not assigned with duplexing directions.

The capabilities include mapping and wake-up time. For example, the WTRU may indicate one or more minimum timing for between a LP-WUS reception and a LP-WUS monitoring, where timing may be different for different types of LP-WUS signals for either reception or transmissions (e.g., one timing for receiving OOK and transmitting OFDM, another for receiving OFDM and transmitting OOK, etc.) or over different carriers, and can also be different than the wake-up time the WTRU requires from a LP-WUs reception to PO monitoring for its own LP-WUS procedure. The timing may be included by the network to determine the scheduling of WTRUs and the mappings between the first LO/MO and the PO.

In an embodiment, a WTRU may receive a configured for DRX configuration that may include UE ID, Paging related configuration (e.g., including the PDCCH resources, periodicity etc.), PEI related configuration, subgroup ID(s).

In an embodiment, a WTRU may receive a first LP-WUS configuration, e.g., from the network, using one or more of SIB, RRC, MAC or DCI-based configuration. The first LP-WUS configuration is the configuration for monitoring its own LP-WUS, i.e., wake-up itself and may include one or more of: Entry/Exit conditions, e.g., measurements configuration and thresholds to enable and disable LP-WUS monitoring; LP-WUS occasions (LOs) and LP-WUS monitoring occasions (MOs), e.g., including associated time/frequency resources, repetitions, signal structure, sequence IDs, etc. DL resources, for example, the LO/MO resources are located in resources designated as DL (e.g., in a DL carrier/cell, DL time resource or DL sub-band) that the WTRU is capable of monitoring; LP-WUS dedicated resources, for example, the LO/MO resources are located in resources dedicated to LP-WUS monitoring, e.g., a dedicated carrier/cell, portions of carriers/cell dedicated to LP-WUS monitoring; the association between LO/MO and the corresponding Paging Occasions (POs); LP-WUS ID and/or LP-WUS subgroup ID; and LP-SS resources, format, structure

In an embodiment, a WTRU may receive a LP-WUS relaying configuration, e.g., from the network, using one or more of SIB, RRC, MAC or DCI-based configuration. The LP-WUS relaying configuration may include:
Configuration and conditions for LP-WUS relaying where these configurations may be a baseline configuration that are completed or replaced by remote-WTRU specific configuration whenever the remote-WTRU specific configuration include similar or contradicting configuration; entry/exit conditions, for example, measurements of network signals configuration and thresholds to enable and disable LP-WUS monitoring. In one option, the entry/exit condition for LP-WUS relaying may be different than the one received for its own LP-WUS monitoring, e.g., where the conditions are more strict to ensure a better reliability of the remote WTRUs; transmit power, for example, the network indicates a transmit power or a max transmit power to use for transmitting LP-WUS/LP-SS; LP-WUS occasions (LOs) and LP-WUS monitoring occasions (MOs) for transmission, e.g., including associated time/frequency resources, repetitions, signal structure, sequence IDs, etc.; and LP-SS resources, format, structure - for transmission. In one example, the different LP-SS may be associated with different spatial filter/beams.

In an embodiment, a WTRU may receive a second (one or multiple) LP-WUS configuration(s), e.g., from the network, using one or more of SIB, RRC, MAC or DCI-based configuration. The second LP-WUS configuration includes the configuration for monitoring remote WTRU's LP-WUS and how to transmit/forward to the remote WTRU and may include one or more of: LP-WUS ID and/or LP-WUS subgroup ID - the one of the remote WTRU; a first set of LP-WUS occasions (LOs) and LP-WUS monitoring occasions (MOs) where the relay WTRU will monitor LP-WUS from the network, e.g., including associated time/frequency resources, repetitions, signal structure, sequence IDs, etc. including DL resources where, for example, the LO/MO resources are located in resources designated as DL (e.g., in a DL carrier/cell, DL time resource or DL sub-band) that the WTRU is capable of monitoring, LP-WUS dedicated resources where, for example, the LO/MO resources are located in resources dedicated to LP-WUS monitoring, e.g., a dedicated carrier/cell, portions of carriers/cell dedicated to LP-WUS monitoring; network LP-SS resources, format, structure and the mapping between network LP-SS and the first set of LO/MO; the association between LO/PO and the corresponding Paging Occasions (POs); a second set of LP-WUS occasions (LOs) and LP-WUS monitoring occasions (MOs) where the relay will transmit LP-WUS to the other WTRU, e.g., including associated time/frequency resources, repetitions, signal structure, sequence IDs, etc. including: UL resources where, for example, the LO/MO resources are located in resources designated as UL (e.g., in a UL carrier, UL time resource or UL sub-band) that the WTRU is capable of monitoring, e.g., similarly as SRS measurements, LP-WUS dedicated resources where, for example, the LO/MO resources are located in resources dedicated to LP-WUS monitoring, e.g., a dedicated carrier/cell, portions of carriers/cell dedicated to LP-WUS monitoring, and resources without definite DL/UL assignment where, for example, the LO/MO resources are located in resources that are not exclusively configured for a given duplexing direction and evolutions of 5G or 6G may be defined without clear DL/UL, allowing having flexible duplexing, full duplexing, overlapping duplexing or resources dynamically configured to a given duplexing direction; the association/mapping between the first set of LO/PO and the second set of LO/PO, i.e., the mapping between the reception of a LP-WUS for another WTRU and the resources on which to transmit/forward the LP-WUS where, for network-managed resources (e.g., UL resources, LP-WUS resource etc.), the network may indicate an explicit, and deterministic mapping of resources and for WTRU-managed resource (e.g., UL configured grant or periodic resources) the WTRU may be configured with a timing window on which to transmit the LP-WUS - min and max delay after the reception of the LP-WUS); LP-SS transmission resources, format, structure, and an association between the LP-SS and the LO/MO to transmit; timing advance offset, for example, the WTRU may receive the indication of a time advance/offset to use for transmission of the LP-WUS to the remote WTRU, e.g., so that the remote/relay WTRU's timing are align, considering the propagation delay; and transmit power. The WTRU may receive an indication of which transmit power to use for the remote WTRU.

At 604, the WTRU receives an indication to activate LP-WUS relaying. For example, in an embodiment, the WTRU receives an indication to activate the relaying of LP-WUS from the network, e.g., as an RRC/MAC/DCI indicating. Upon reception of the indication, the WTRU may start monitoring LP-WUS on the corresponding resources. In some examples: the WTRU receives an indication of an activation including the remote UE ID or subgroup to monitor, e.g., in the case where the WTRU is already configured with the LP-WUS relaying for that WTRU; the WTRU may receive the indication as a form of receiving the relaying configuration, and being configured implicitly indicating the activation of the relaying feature; the WTRU may receive the indication as a form of activation of a semi-persistent resource, e.g., the UL resource for forwarding the LP-WUS, and implicitly activates the relaying for the remote WTRUs for which these resources are used to relay LP-WUS; and the indication may also include updated configuration for the monitoring and/or LP-WUS transmission to the remote WTRU, e.g., include a timing advance offset and/or a transmit power indication.

In an embodiment, the WTRU may receive an indication to deactivate the LP-WUS relaying and stop monitoring for the remote WTRU's LP-WUS resources. Similarly, the indication may be received from the network or the remote WTRU, indicating the remote WTRU id/subgroup, removing the configuration or deactivating the resource to monitor/transmit the LP-WUS etc. In another example, the WTRU in IDLE/INACTIVE mode, may be configured by default to monitor the LO/MO resources and prepare to relay any configured LP-WUS relaying—as the WTRU may no longer receives RRC/MAC/DCI indication from the network. The WTRU may also receive an indication of reconfiguration from the network, e.g., using a paging and/or reconfiguration indication.

After receiving the indication to relay LP-WUS or after receiving the configuration to relay LP-WUS, the WTRU may evaluate whether conditions for LP-WUS relaying are satisfied. For example, the WTRU may be configured with measurement conditions, e.g. including measurement resources, configuration and thresholds and perform the corresponding measurements. For instance, measurements based on SSB or CSI-RS. The WTRU mays also be configured with LR measurements based on LP-SS or LP-WUS measurements. The measurements may be similar to evaluating entry conditions, although the thresholds may be different. When the WTRU evaluates that the measurements are beyond the thresholds, the WTRU may start monitoring/relaying the LP-WUS for the remote WTRU. If the WTRU evaluates that the measurements are below the thresholds, the WTRU may report to the network that the WTRU is not able to monitor/relay the LP-WUS, e.g., based on RRC, MAC or UCI report.

At 606, the WTRU measures and evaluates that conditions are satisfied and reports this to the network. The WTRU may be configured with measurement conditions, e.g. including measurement resources, configuration and thresholds and perform the corresponding measurements. For instance, measurements based on LP-SS or LP-WUS measurements. The measurements may be similar to evaluating exit conditions, although the thresholds may be different. When the WTRU evaluates that the measurements are beyond the thresholds, the WTRU may keep monitoring/relaying the LP-WUS for the remote WTRU. If the WTRU evaluates that the measurements are below the thresholds, the WTRU may report to the network that the WTRU is no longer able to monitor/relay the LP-WUS, e.g., based on RRC, MAC or UCI report. If the WTRU had its MR off, the WTRU may turn the MR back on to indicate to the network and/or restart monitoring its own DRX paging occasions.

At 608, the WTRU monitors one or more sets of LO/MO resources for remote WTRUs and/or its own LO/MOs. In an embodiment, the WTRU monitors the LO/MO of the remote WTRUs, based on the received indication and configurations. In some examples: the WTRU is in IDLE/INACTIVE mode and monitors other WTRUs with MR ON and LR ON; the WTRU may have both radios ON and monitor for LO/MO of the second LP-WUS configuration, while not monitoring its own LO/MO (first configuration). For example, this may happen if the entry/exit conditions are different and/or if the relay WTRU timing for LO/MO monitoring is different or needing the MR for other purposes (e.g., recently received message, waking-up for PDCCH monitoring, initiating RACH/preparing UL transmission, mobility-related measurement, etc.); the WTRU is in IDLE/INACTIVE mode and monitors other WTRUs and its own LO/MO with MR OFF and LR ON, for example, the WTRU may configure itself to monitor LO/MO of both the first and second configuration for LP-WUS, including detecting WTRU ID/subgroup based on the first and second configurations; the WTRU is in CONNECTED mode and monitors other WTRUs with MR ON and LR ON; the WTRU may have ongoing traffic and be in RRC CONNECTED mode, or did not yet switch to IDLE/INACTIVE mode, while monitoring for LP-WUS for other WTRUs; and the WTRU is in CONNECTED mode and monitors other WTRUs with MR OFF (or a deep sleep) and LR ON. For example, the WTRU may also be in CONNECTED mode, monitoring CONNECTED mode LP-WUS for itself, e.g., based on network indication, and also monitor LO/MO of the remote WTRUs.

Examples include, the WTRU may be capable of monitoring LP-WUS signals using MR, e.g., if MR supports the LP-WUS formats and on the corresponding resources. In this case, the WTRU may use its MR to monitor the LO/MO of remote WTRUs, e.g., in the case where the WTRU has its MR ON for its own needs/traffic, to avoid activating both radios. The WTRU may be configured to monitor different types/format of LP-WUS signals, e.g., a first type of signal/format for its own configuration (e.g., OFDM in the first configuration) and a second type for the remotes (e.g., OOK in the second configuration). In some cases, multiple monitored WTRUs (including self) may have the same LO/MO resources and the WTRU may monitor a common resources.

At 610, the WTRU receives a LP-WUS and detects the target of the LP-WUS. In an embodiment, the WTRU is configured to detect, in the received signals in the LOs/MOs the corresponding sequences or decode the corresponding IDs/subgroup indications, based on the different configurations, for example its own ID or subgroup in the first set of configuration and the remote WTRU's ID/subgroup in the second set(s) of configurations. In some examples the subgroups to detect/identify are different for the different WTRUs (remote/self), at least on different LO/MOs and the WTRU performs detection for each ID/subgroup in each corresponding resources, and the subgroups to detect/identify may be the same for multiple WTRUs (remote/self), and the WTRU may perform the detection/identification of a reduced number of subgroups, reducing the complexity and power consumption of the WTRU, although subgroups are typically configured by the network (gNB or core network).

In the case where the WTRU does not detects or receive a LP-WUs in the determined LO/MO, the WTRU does not wake-up its MR (if MR OFF) and does not forward an indication to the remote WTRUs. It simply “waits” and prepares to monitor the next LO/MO.

In the case where the WTRU detects a LP-WUS in one of the monitored LO/MO, but is unable to detect/decode the corresponding ID/subgroup or if the detected/decoded ID/subgroup is not belonging the monitored IDs/subgroups, the WTRU does not wake-up its MR, if MR OFF, and does not transmit an indication to the remote WTRUs. It simply “waits” and prepares to monitor the next LO/MO.

At 620, the WTRU determines the LP-WUS corresponds with a relay, and at 622, the WTRU returns to monitoring the one or more sets of LO/MO resources. In the case where the WTRU detects a LP-WUS in the first set of LO/MO and where the ID/subgroup corresponds to the (relay) WTRU ID/subgroup, the WTRU wake-up its MR and prepares to monitor the corresponding PDDCH, based on the LO/MO to PDCCH mapping in the first set of configuration, and follow the normal behavior following the wake-up for itself. The WTRU may however, contrary to “legacy” behavior, keep its LR ON and keep monitoring LO/MOs for the configured remote WTRUs. The WTRU, if capable, may configure its MR to monitor remote WTRU's LO/MO to be able to turn its LR off.

At 614, the WTRU determines UL resources to transmit the LP-WUS. In the case where the WTRU detects a LP-WUS in a LO/MO, and the WTRU detects/identifies a subgroup/ID corresponding to one/mote remote WTRUs, the WTRU may prepare itself to transmit the LP-WUS to the corresponding WTRUs. Preparing itself may include waking-up the MR, determining the resources on which to transmit and transmitting the LP-WUS. In the same time, the WTRU may keep monitoring LO/MO for itself and/or for other remote WTRUs.

In an embodiment, during the monitoring of remote WTRU's LO/MO, the WTRU may have received the configuration to send a LP-SS, e.g., a synchronization signal used by remote WTRUs to synchronize and help the reception of LP-WUS and/or perform measurements. The WTRU may use the received configuration to determine LP-SS resources and beams with which to transmit the LP-SS. When the WTRU is required to transmit the LP-SS, the WTRU may turn on if MR, if MR is off, and prepare ahead of time to transmit the LP-SS based on configuration. The WTRU may transmit one or more LP-SS, e.g., using different beams and/or different LP signal format, based on remote WTRU's configurations.

In one solution, the WTRU received a LP-WUS and identified one or more remote WTRU's ID/subgroups in the LP-WUS. The WTRU may then determine the resources on which to transmit the LP-WUS based on the received mapping configuration for the corresponding WTRU. In some examples: if multiple remote WTRUs are identified in the received LP-WUS (e.g., due to multiple WTRU sharing a subgroup ID or due to multiple subgroup/id indications), the WTRU may determine multiple LP-WUs transmission resources and treat each WTRU separately; the WTRU may prepare to transmit/repeat the transmission on multiple resources, e.g., if the remote WTRU configuration includes multiple LO per MO (e.g. one per LP-SS/beam) and/or multiple MOs; and the WTRU may consider the LO/MO resources to transmit on based on the received remote WTRU-specific resource configuration, e.g., using that identified WTRU's resource mapping (i.e. based on the identified ID/subgroup ID).

The WTRU may have received a configuration including a periodic (or semi-periodic) UL resource on which to transmit LP-WUSs to remote WTRUs, and a minimum/max delay between LP-WUS reception and LP-WUS transmission, the WTRU may then determine the resource(s) corresponding to the delay constraints and prepare itself for transmission on these resources, e.g., the next configured resource after the minimum delay.

The WTRU may have received an explicit resource mapping between the LP-WUS reception and LP-WUS transmission resources, instead of min/max delays, and use this resource association to determine the LP-WUs transmission resources, e.g., based on the mapping corresponding to the identified ID/subgroup ID.

At 616, the WTRU transmits the LP-WUS. In an embodiment, the WTRU transmits the LP-WUS in the determined resources, targeting the remote WTRU(s). The WTRU uses the remote-WTRU specific configuration to transmit the LP-WUS. In some examples, the WTRU transmits an LP-WUS using the LP-WUS type and format (e.g., OOK or OFDM) configured for the remote WTRU, and the WTRU transmits an LP-WUS including the WTRU ID/subgroup ID of the remote WTRU.

In one example, the ID/subgroup is the same as the one received in the LP-WUS to forward. In another example, the WTRU is configured with a distinct WTRU ID/subgroup ID for its remote WTRUs, e.g., received in the LP-WUS relaying configuration, and maps the received ID/subgroup to the transmission WTRU ID/subgroup.

The WTRU may transmit the LP-WUS using a specific time advance/time offset. In one example, the WTRU uses the same timing as used for the LP-SS transmissions In one example, the WTRU uses the same timing as used for its own UL transmissions or its own DL receptions, or a preconfigured fraction of them (e.g., half of the UL or DL timing advance/offset). In one example, the WTRU uses a preconfigured value, e.g. no TA (TA=0). In one example, the WTRU received a configuration with a generic timing configuration, e.g., as part of the LP-WUS relaying configuration and uses this generic timing. In one example, the WTRU received a remote WTRU specific timing configuration (e.g., in the LP-WUS relaying configuration or in an activation indication) and uses the time configuration corresponding to the targeted remote WTRU.

The WTRU may transmit the LP-WUS using a specific transmit power. In one example, the WTRU uses the same transmit power as used for the LP-SS transmissions. In one example, the WTRU uses the same transmit power as used for its own UL transmissions or a preconfigured offset of (e.g., transmit power −3 dB). In one example, the WTRU uses a preconfigured value, e.g. max transmit power, max transmit power-offset; etc. In one example, the WTRU received a configuration with a generic transmit power configuration, e.g., as part of the LP-WUS relaying configuration and uses this generic transmit power. In one example, the WTRU received a remote WTRU specific transmit power configuration (e.g., in the LP-WUS relaying configuration or in an activation indication) and uses the transmit power configuration corresponding to the targeted remote WTRU.

As illustrated at 618, once the WTRU has transmitted the LP-WUS targeting the identified remote WTRUs, the WTRU may keep monitoring LO/MOs of the different remote WTRU configured (and also its own). In some examples, the WTRU may turn back its MR off if LP-WUS entry conditions are satisfied.

In an alternative embodiment, the WTRU, e.g., in RRC CONNECTED mode, may be configured to not turn on its LR and instead may receive direct network indications to wake-up one or more remote WTRUs. For instance, the WTRU may receive an RRC, MAC or DCI indication directly from the network. The indication may include the remote WTRU ID/subgroups to wake-up and/or the associated LP-WUS resource to use for LP-WUS transmission. In one example, the WTRU receives a DCI grant for an UL transmission, where the DCI includes an indication of being a LP-WUS transmission and may include the corresponding resource to use or a mapping or indication to a preconfigured resource to use. The indication may include the format of the transmission and/or any transmission configuration required for specific transmission (timing offset, transmit power, etc.)

Upon reception of the LP-WUs transmission command, the WTRU prepares the transmission and transmit on the configured resource using the configured format, timing, power etc. This avoids the relay WTRU to monitor for LP-WUs itself but requires the network to perform according scheduling and the relay WTRU needs to be CONNECTED which is battery consuming. This approach may also be used by the network to let a potential relay WTRU perform some LP-WUS transmission and let other WTRUs perform WTRU-based LP-WUS measurements, e.g., for relay discovery/selection procedure.

In one example, the WTRU may be configured with an UL resource to transmit a LP signal, e.g., LP-SS or LP-WUS including the necessary LP signal configuration such as format, sequence, ids, etc. The WTRU may receive the indication from RRC, MAC or DCI, e.g., depending on whether the signal is periodic, semi-periodic with (de)activation or dynamic. The WTRU then transmits the configured LP signal on the configured resources. If selected by the other WTRU or network, the WTRU then receives a set of configurations for LP-WUS relaying of a given remote WTRU including the configuration for LP-WUS monitoring resources and LP-WUS transmissions, e.g., specific to that WTRU. The configuration may be remote WTRU-specific and be based on the remote WTRU's measurements, e.g. for time advance or transmit power.

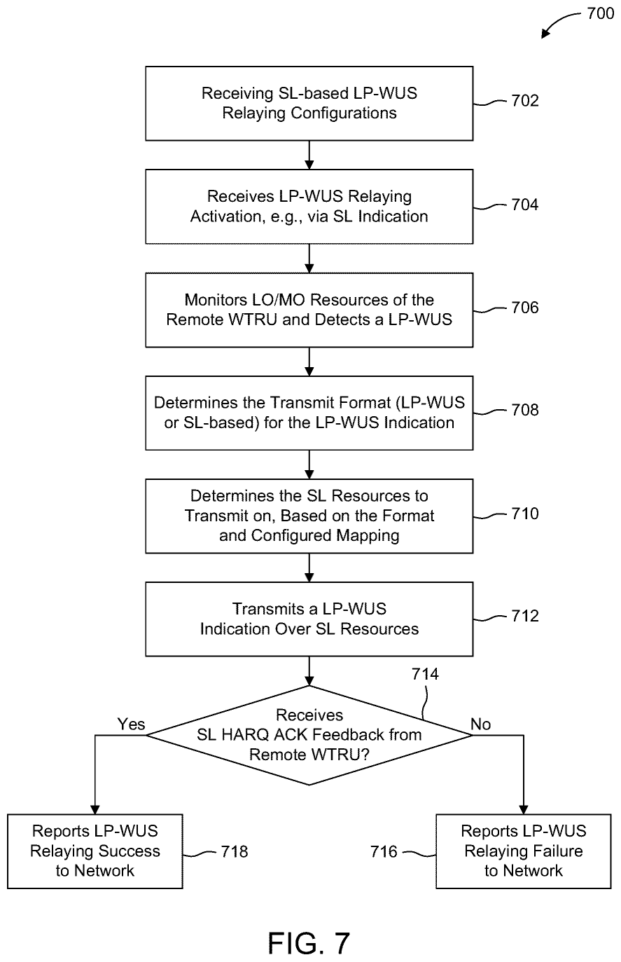

FIG. 7 is a flow diagram of an example for LP-WUS coverage extension process with a sidelink.

At 702, the WTRU receives SL-based LP-WUS relaying configurations. In an embodiment, the relay WTRU may be connected to a remote WTRU via a SL/PC5 connection and may have direct communications between them. The relay WTRU may receive a configuration to perform LP-WUS relaying to the remote, this may include using SL resources to transmit LP-WUS or receive SL-based transmissions from the remote, e.g., for (de)activation. Note that here the description is related to the SL/PC5 connection. However, the corresponding methods, process, and apparatus apply to any WTRU-WTRU (UE-UE) communication.

Several aspects of this embodiment are similar to those described in previous sections, and the SL connection can be used as a complement or replacement of one or more of the different aspects, procedures, and processes described in previous embodiments. For example, at 704, the WTRU receives a LP-WUS activation via sidelink, and at 705, the WTRU monitors the LO/MOs resources of the remote WTRU. The WTRU may determine the transmit format at 708, and determine the SL resources to transmit on at 710.

In an embodiment, the WTRU may transmit to the network the SL capabilities, LP-WUS-related SL capabilities (e.g., capability to receive/transmit indication to a LP-remote WTRU via SL), its active SL connections (e.g., list of ongoing SL connections and the corresponding WTRUs), etc. In SL, WTRUs may be identified using WTRU IDs or SL WTRU ID (e.g., L2 ID, Destination L2 ID, C-RNTI, Local ID, application ID).

In an example embodiment, the WTRU receives the LP-WUS relaying configuration for a remote WTRU with which it has a SL connection established. The configuration, in addition to the previous indications mentioned, may further include: LO/MO and LP-SS resources for transmissions over SL, where, for example, the LP-SS, LO/MO resources for transmissions are configured in resources designated as SL (e.g., in a SL carrier/BWP, SL time resource/resource pool) that the WTRU is capable/configured to monitor. In one example, the WTRU is configured to transmit the LP-WUS over SL resources configured with autonomous resource selection (e.g., NR SL Mode 2). In another example, the WTRU is configured to transmit the LP-WUS over SL resources configured with grant-based resource selection (e.g., NR SL Mode 1). In one example, when the WTRU is configured to transmit SL-SS, the WTRUs may be configured so that the LP-SS and SL-SS are the same signals, or that the WTRU is not required to transmit the LP-SS (as the remote may monitor SL-SS instead)

The configuration may include the association/mapping between the first set of LO/PO and the second set of LO/PO, i.e., the mapping between the reception of a LP-WUS for another WTRU and the resources on which to transmit/forward the LP-WUS. For network-managed resources (e.g., SL Mode 1) the network may indicate an explicit and deterministic mapping of resources For WTRU-managed resource (e.g., SL Mode 2, the WTRU may be configured with a timing window on which to transmit the LP-WUS - min and max delay after the reception of the LP-WUS)

In one aspect, the WTRU may receive this information from the network, e.g., using SIB, RRC, MAC or DCI indications. In another aspect, the WTRU may receive this information from the remote WTRU, e.g., using SL RRC, SL MAC or SCI indications. In one alternative embodiment, the WTRU may transmit these LP-WUS relaying configuration to the relay WTRU, instead of receiving it, e.g., using SL RRC configuration, SL MAC and/or SCI.

In an embodiment, the WTRU may receive an (de)activation of the LP-WUS relaying over SL, indicating to start/stop the monitoring of a remote's WTRU. The WTRU may receive the SL indication directly from the remote WTRU, i.e., as an indicated source in the SCI of the transmission. Upon reception of the indication, the WTRU start/stops monitoring the LP-WUS corresponding to the remote WTRU's LO/MOs. In some examples: the WTRU may receive the indication within a dedicated new SCI or SCI indication; the WTRU may receive the indication as part of a SL MAC CE or SL RRC configuration; and the WTRU may receive the indication as a SL unicast transmission, a SL groupcast transmission or a SL broadcast transmission

In an embodiment, the WTRU may be configured and evaluate WTRU-WTRU related conditions to activate/deactivate the LP-WUS relaying, e.g., in complement with previous conditions. For instance: the WTRU may be configured with SL measurement, e.g., if WTRUs have established a SL/PC5 connection, and the WTRU may perform SL-RSRP/SL-RSSI measurements on SL transmissions made from the remote WTRU. If the measurement is beyond the threshold, the WTRU may perform the LP-WUS relaying; and the WTRU may be configured to perform SL positioning and evaluate the distance between the relay and remote WTRUs. If the distance is lower than a threshold, the WTRU may perform the LP-WUS relaying

In one aspect, the WTRU may receive a LP-WUS targeting a configured remote WTRU in the corresponding LO/PO resources. The WTRU then determines the SL resources to transmit the LP-WUS on, based on the configured mapping and/or the received signal indication/resources. In case the WTRU is configured with network managed resources, the WTRU may transmit the LP-WUS over the resource determined using an explicit mapping/rule from the network configuration, e.g., a next available resource after a min timing offset, for resources corresponding to this LP-WUS relaying configuration. In case the WTRU is configured with autonomous resource selection, the WTRU may select a resource in a resource pool with a min/max delay, and/or based on the LO/MO resources configured for SL transmission of the LP-WUS for that remote WTRU.

In another aspect, the LO/MO resources for LP-WUS transmission correspond to the SL-DRX resources for the remote WTRU, or a subset of it. In another aspect, the LO/MO resources for LP-WUS transmission are different to the SL-DRX resources for the remote WTRU, and the remote WTRU may use different radio to monitor the different signals.

At 712, the WTRU transmits the LP-WUS with transmission parameters related to the SL transmissions. For example: the WTRU may use a transmit power based on the SL transmit power for that remote WTRU, e.g., based on (previous) SL measurements or estimated pathloss, or SL power control loop for the remote WTRU; the WTRU may also use SL-based measurements or timing to adjust the timing of the LP-WUS transmission over SL, to target the remote WTRU; and the WTRU may use a beam that is targeting the remote WTRU, if any is configured for that remote WTRU. The WTRU may also use multiple transmissions for the different LOs with different beams, e.g., performing a beam sweeping.

In an embodiment, the WTRU may be configured with SL-DRX with the remote WTRU and LP-WUS relaying configurations, where the remote WTRU monitors both resources, e.g., with distinct radios. The relay WTRU, upon reception of the LP-WUS targeting the remote WTRU, may determine whether to transmit the LP-WUS indication over the LO/MO resource or send a direct SL indication (including a wake-up indication), e.g., based on the timing for the SL-DRX or LO/MO resources.

In an embodiment, the WTRU may use LP-WUS transmission if the next available resource for transmission to the remote, comparing the SL DRX and LO/MO monitoring resources is a LP-WUS resource. In one example, the WTRU may use SL transmission if the next available resource for transmission to the remote, comparing the SL DRX and LO/MO monitoring resources is a SL resource. In another example, the WTRU may use the LP-WUS transmission if the timing between the LO/MO and the PDCCH monitoring of the remote WTRU is more than the received wake-up time indication of the remote, and/or if the timing between the SL reception to PDCCH monitoring of the remote WTRU is less than the received wake-up time indication of the remote WTRU for SL to PO timing.

In another example, the WTRU may use the SL transmission if the timing between the LO/MO and the PDCCH monitoring of the remote WTRU is less than the received wake-up time indication of the remote, and/or if the timing between the SL reception to PDCCH monitoring of the remote WTRU is more than the received wake-up time indication of the remote WTRU for SL to PO timing. In another example, the WTRU may select the SL transmission if the WTRU has other SL transmission to perform on the SL monitoring resources time, e.g. to the remote or to other WTRUs.

In an embodiment, the WTRU transmits the LP-WUS indication in a SL transmission, e.g., in a PSCCH/PSSCH/PSBCH transmission to the remote WTRU. The WTRU may include an explicit indication that the transmission is intended as a LP-WUS signal, i.e., indicating the need for the remote WTRU to wake-up its radio e.g. for PDCCH monitoring. The WTRU may include indications such as the PDCCH resources to monitor, the intended remote WTRU ID/subgroup.

In this aspect, the WTRUs may autonomously manage and configure the LP-WUS relaying with limited to no indication from the network. The WTRUs, e.g., a set of WTRU from a same group of devices (XR, IoT, industrial devices/sensors etc.) or belonging to a same user, may have (pre)configuration to perform LP-WUS relaying to each other. The following aspect may be considered as complement or replacement of network-controlled versions described previously, in all or parts.

In an embodiment, the WTRU may send its SL capabilities, LP-WUS monitoring and LP-WUS relaying capabilities to another WTRU, e.g., via SL RRC, SL MAC CE or SCI indications, or obtained through pre-configurations. In another aspect, the WTRU may receive the LP-WUS relaying configuration from another WTRU, e.g., including the LP-WUS monitoring configurations (LO/MO resources, timings, IDs/subgroup, etc.) that the WTRU requires to monitor the LO/MO of the remote WTRU e.g., via SL RRC, SL MAC CE or SCI indications.

In yet another aspect, the WTRU may receive from the remote WTRU a configuration for transmitting the LP-WUS indication, e.g., using LP-WUS and/or SL based indication, and including the resources on which to transmit. For instance, using SL resources.

In an alternative embodiment, the WTRU may transmit to the remote WTRU a configuration for receiving the LP-WUS indication, e.g., using LP-WUS and/or SL based indication, and including the resources on which to receive. For instance, using SL resources.

In another aspect, the WTRU may receive an indication from the remote WTRU to monitor its LP-WUS, e.g., via SL RRC, SL MAC CE or SCI indications and may start to monitor the remote WTRU LO/MO resources to detect the corresponding ID/subgroup indication.

In an embodiment, the WTRU may monitor the LO/MO of the remote and detect a LP-WUS targeting the remote WTRU. The WTRU then transmits the indication to the remote WTRU, using the configured resources for LP-WUS indication transmission.

In one example embodiment, a network may configure a SL feedback configuration for LP-WUS relaying to a relay WTRU (e.g., LP-WUS relay WTRU) and/or a remote WTRU (e.g., LP-WUS remote WTRU). For example, the relay WTRU and/or the remote WTRU may receive an RRC message (e.g., cell-specific and/or dedicated WTRU) for configuring the SL feedback configuration for LP-WUS relaying. For example, the SL feedback configuration may comprise one or more SL resource pools (e.g., SL transmission/reception) and/or associated SL logical channels. For example, the SL feedback configuration may comprise at least one SL resource pool configured with PSFCH (Physical Sidelink Feedback Channel) and/or associated at least one SL logical channel with SL feedback being enabled.

In an example, a relay WTRU may configure a SL feedback configuration to a remote WTRU via PC5 interface (e.g., PC5-RRC message) after a PC5-RRC connection established between relay WTRU and remote WTRU. For example, a relay WTRU may configure additional/dedicated configuration of LP-WUS monitoring for the remote WTRU. For example, the configuration may comprise a specific (or a portion of) SL resource pool(s) and/or time window and/or time duration and/or PSCCH/PSSCH and/or a specific SL BWP for LP-WUS monitoring. For example, a relay WTRU may configure additional/dedicated configuration of SL feedback of LP-WUS reception for the remote WTRU. For example, the configuration may comprise a specific (or a portion of) SL resource pool(s) and/or time window and/or time duration and/or PSCCH/PSFCH and/or a specific SL BWP for feedback of LP-WUS reception.

In another example, a relay WTRU (e.g., LP-WUS relay WTRU) may transmit an LP-WUS to a remote WTRU (e.g., LP-WUS remote WTRU) upon receiving an LP-WUS from a network. For example, the relay WTRU may transmit the received LP-WUS via an SL transmission with an SL resource transmission pool configured with PSFCH resource. For example, the relay WTRU may perform multiplex into the same (or different) SL MAC PDU configured with one or more SL logical channels (e.g., SL feedback is enabled). For example, one LP-WUS relaying transmission is associated with at least one SL HARQ feedback and/or at least one SL HARQ process ID. For example, LP-WUS may be transmitted within an SL TB and/or piggybacking/multiplexed with SL data within an SL TB.

If the WTRU does not receive feedback from the remote WTRU, at 714, the WTRU reports a LP-WUS failure report to the network at 716. The WTRU may report LP-WUS relaying success at 718. Upon transmitting an SL transmission including LP-WUS, a relay WTRU may receive one or more SL feedback (e.g., ACK/NACK) via PSFCH resource from remote WTRU(s) as a response of the SL transmission of the LP-WUS. Upon receiving the SL feedback of LP-WUS from a remote WTRU, a relay WTRU may report the received ACK/NACK via PUCCH to the network. For example, network may know whether LP-WUS relaying for a remote is succeed or not based on the feedback from the relay WTRU. For example, network may perform retransmission of LP-WUS upon receiving the NACK from the relay WTRU. For example, a relay WTRU perform retransmission of LP-WUS for the remote WTRU upon receiving LP-WUS from network.

In an embodiment, upon receiving an indication of activation of LP-WUS relaying from a network, a relay WTRU may transmit an LP-WUS to a remote WTRU. For example, the network may transmit an indication (or a message) via DCI/MAC CE/SIB/RRC message. For example, the indication may include one or more remote UE ID (e.g., L2 ID, Destination L2 ID, C-RNTI, Local ID, application ID). For example, the indication may include information for initial transmission and/or retransmission of LP-WUS. In one example, upon receiving an LP-WUS with at least one remote UE ID and/or LP-WUS subgroup ID, a relay WTRU may determine to transmit the received LP-WUS to the specific remote WTRU and/or group of remote WTRUs. For example, a relay may perform unicast LP-WUS relaying for a remote WTRU and/or may perform groupcast for LP-WUS relaying for a subgroup based on the reception ID(s).

In another example, a relay WTRU may determine to activate/perform LP-WUS relaying for a remote WTRU. For example, measured SL-RSRP/SL-RSRQ/SL-RSSI is above than the configured threshold (e.g., SL entry condition is satisfied). In yet another example, a relay WTRU may determine to activate/perform LP-WUS relaying for a remote WTRU once the relay WTRU is satisfied with configured LP-WUS entry condition. For example, measured MR measurement results and/or LR measurement results is above than the thresholds (e.g., entry condition is satisfied).

In an example, a relay WTRU may receive an explicit request of LP-WUS relaying from a remote WTRU. For example, the relay WTRU may receive a PC5-RRC message including LP-WUS relaying request.

In one example, upon receiving an indication of deactivation of LP-WUS relaying from network, a relay WTRU may stop transmitting/relaying an LP-WUS to a remote WTRU. In another example, a relay WTRU may determine to deactivate LP-WUS relaying for a remote WTRU if measured SL-RSRP/SL-RSRQ/SL-RSSI is below than the configured threshold (e.g., SL exit condition is satisfied). In another example, a relay WTRU may determine to deactivate LP-WUS relaying for a remote WTRU once the relay WTRU is satisfied with LP-WUS exit condition. For example, measured MR measurement results and/or LR measurement results is below than the thresholds (e.g., exit condition is satisfied).

In an example, a relay WTRU may determine to deactivate LP-WUS relaying for a remote WTRU once the relay WTRU determine to move to another cell (e.g., handover, cell (re-)selection). For example, the relay WTRU may send an explicit request of deactivation to the remote due to relay WTRU's mobility. In another example, a relay WTRU may determine to deactivate LP-WUS relaying for a remote WTRU once the number of DTX is reached to a configured threshold. For example, a relay WTRU may increase the number of DTX if the relay WTRU fails to receive feedback related SL transmission with LP-WUS relaying. For example, a relay WTRU determines to deactivate LP-WUS relaying with a remote WTRU once PC5-RRC connection is released and/or upon detection of SL-RLF for the PC5-RRC connection.

In an embodiment, a relay WTRU may receive an explicit request of deactivation for LP-WUS relaying from a remote WTRU. For example, the relay WTRU may receive a PC5-RRC message including LP-WUS relaying request.

In an aspect, a relay WTRU may determine to activate/perform LP-WUS relaying for a remote WTRU when the measured SL-RSRP/SL-RSRQ/SL-RSSI from remote WTRU is above than a threshold (e.g., successful for SL data transmission is satisfied). In another example, a relay WTRU may determine to activate/perform LP-WUS relaying for a remote WTRU when relay WTRU condition (e.g., L2 relay and/or L3 relay WTRU) is satisfied. In yet another example, a relay WTRU may determine to activate upon receiving PC5-capability information (e.g., supporting OOK based LP-WUR and/or OFDM based LP-WUR) from remote WTRU.

In an embodiment, a relay WTRU may determine to deactivate LP-WUS relaying for a remote WTRU once the measured SL-RSRP/SL-RSRQ/SL-RSSI from remote WTRU is below than a threshold. (e.g., successful SL data transmission is not satisfied).

In one aspect, a relay WTRU may determine to deactivate LP-WUS relaying for a remote WTRU when relay WTRU condition (e.g., L2 relay and/or L3 relay WTRU) is not satisfied. Combinations of the above factors are also possible: one or another condition (e.g., explicit/implicit) being satisfied, multiple conditions being satisfied, a threshold for one condition being computed by another factor, etc.

In one example, a remote WTRU (e.g., LP-WUS remote WTRU) receive an LP-WUS from a relay WTRU (e.g., LP-WUS relay WTRU). Upon receiving the LP-WUS from the relay WTRU, the remote WTRU may transmit/respond SL feedback (ACK/NACK) via PSFCH resource for the reception of LP-WUS from relay WTRU.

In an example, upon receiving an LP-WUS from a relay WTRU, a remote WTRU may monitor and respond for the reception of LP-WUS. In another example, a remote WTRU may determine to activate/perform LP-WUS relaying from a relay WTRU. For example, measured SL-RSRP/SL-RSRQ/SL-RSSI is above than a configured threshold (e.g., SL entry condition is satisfied).

In another aspect, a remote WTRU transmit an explicit request of LP-WUS relaying to the relay WTRU once detecting the LP-WUS exit condition being satisfied. For example, measured MR measurement results and/or LR measurement results is below than the thresholds (e.g., exit condition is satisfied). For example, the remote WTRU may transmit a PC5-RRC message including LP-WUS relaying request of activation. In an example, the remote WTRU may transmit a PC5-RRC message including LP-WUS relaying request of activation. For example, the request activation may comprise PC5-capability information (e.g., supporting OOK based LP-WUR and/or OFDM based LP-WUR).

In one example, upon receiving an indication of deactivation of LP-WUS relaying from a relay WTRU, the remote WTRU may stop monitor and receive LP-WUS from a relay WTRU. In another example, a remote WTRU may deactivate to monitor LP-WUS relaying signal from a relay WTRU if measured SL-RSRP/SL-RSRQ/SL-RSSI is below than a configured threshold. (e.g., SL exit condition is satisfied).

In yet another example, a remote WTRU may deactivate to monitor LP-WUS relaying signal from a relay WTRU once the remote WTRU is satisfied with LP-WUS entry condition. For example, measured MR measurement results and/or LR measurement results is above than the thresholds (e.g., entry condition is satisfied). For example, the remote WTRU may transmit a PC5-RRC message including LP-WUS relaying request of deactivation.

Combinations of the above factors are also possible: one or another condition (e.g., explicit/implicit) being satisfied, multiple conditions being satisfied, a threshold for one condition being computed by another factor, etc.

In an embodiment, a Relay WTRU may be configured to: send a LP-WUS forwarding capability request including: LP-WUS transmit power, LO forwarding min delay, max. number of LO monitoring; receive a configuration from the network for LP-WUS coverage extension including: a configuration to monitor the LP-WUS of the remote including LO/MO resource occasions and configuration of the remote WTRU and ID/subgroups, a configuration for LP-WUS transmission/forwarding for remote WTRU(s), this configuration including: a Min/Max delay between reception of LP-WUS and forwarding of the LP-WUS to the remote, configurations for LP-WUS forwarding transmissions and LP-SS transmissions, for each remote WTRU, for example, the LP-WUS format (OFDM, OOK) and content (target ID/subgroup) and semi-Persistent resources on UL, and conditions for relaying, which may include activation/deactivation criteria, e.g., based on MR/LR thresholds.

The Relay WTRU may be further configured to: receive indication to start monitoring remotes'LP-WUS, for example, as an RRC/MAC/DCI indicating the remote WTRU(s) to forward to, as an indication activating the SP resource for forwarding, and an indication may include a remote WTRU specific: timing alignment, transmit power indication; evaluate and determine that conditions are satisfying to perform LP-WUS relaying, e.g., based on network measurements over a threshold; report to the network the activation of the LP-WUS relaying; monitor the LP-WUS using remote WTRU(s) configuration and transmit the LP-SS on configured resources, if the WTRU detects/measures that a deactivation criterion is met, e.g., based on LR measurements, send a report to the network to stop monitoring the LP-WUS; receive the LP-WUS targeting the remote WTRU, e.g. based on subgroup/WTRU ID; determine an UL resource to transmit the LP-WUS, based on the received LP-WUS resource/timing and the mapping between the LP-WUS reception and forwarding, for example, the next LP-WUS resource available after the reception of LP-WUS+configured delay; transmit the LP-WUS to the specific remote WTRU using determined resource, and remote WTRU-specific timing and power. If no specific timing is configured (or too old), reset timing to 0.

In another embodiment, a Relay WTRU may be configured to: receive the configuration for LP-WUS relaying over SL, including, for example, LP-WUS monitoring resources of the remote WTRU, LP-WUS transmission resources and configuration (e.g., on SL Mode 2 resources, with a min/max delay) and remote WTRU's SL DRX configuration, or LP-WUS relaying confirmation configuration, e.g., enabling the feature, associated SL HARQ resources and reporting timing.

The Relay WTRU may be configured to: receive an indication for LP-WUS relaying activation, e.g., via SL indication including the remote WTRU's ID; monitor the LP-WUS using remote WTRU(s) configuration and transmit the LP-SS on configured (SL) resources; receive the LP-WUS targeting the remote WTRU, e.g. based on subgroup/WTRU ID; determine to transmit the LP-WUS indication using SL transmission or LP-WUS transmission, e.g., based on LO/MO resources timing, SL DRX timing and remote's PO monitoring timing; transmit the LP-WUS indication to the remote WTRU, e.g., on SL resources; at 714 receive a SL HARQ feedback indication from the remote WTRU; and at 718 report the LP-WUS safe reception to the network, e.g. using PUCCH/PUSCH indication.

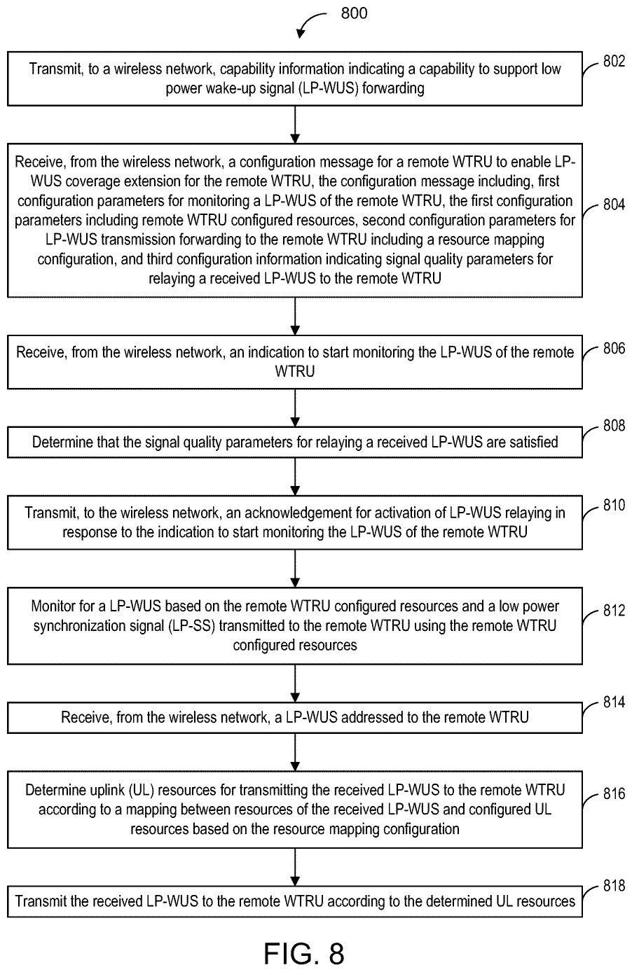

FIG. 8 is a flowchart of an example LP-WUS coverage extension process 800. In some implementations, one or more process blocks of FIG. 8 may be performed by a WTRU.

As shown in FIG. 8, process 800 may include, at 802, transmitting, to a wireless network, capability information indicating a capability to support low power wake-up signal (LP-WUS) forwarding. For example, a WTRU may transmit, to a wireless network, capability information indicating a capability to support low power wake-up signal (LP-WUS) forwarding, as described above. As also shown in FIG. 8, process 800 may include, at 804, receiving, from the wireless network, a configuration message for a remote WTRU to enable LP-WUS coverage extension for the remote WTRU, the configuration message including, first configuration parameters for monitoring a LP-WUS of the remote WTRU, the first configuration parameters including remote WTRU configured resources, second configuration parameters for LP-WUS transmission forwarding to the remote WTRU including a resource mapping configuration, and third configuration information indicating signal quality parameters for relaying a received LP-WUS to the remote WTRU. For example, the WTRU may receive, from the wireless network, a configuration message for a remote WTRU to enable LP-WUS coverage extension for the remote WTRU, the configuration message including, first configuration parameters for monitoring a LP-WUS of the remote WTRU, the first configuration parameters including remote WTRU configured resources, second configuration parameters for LP-WUS transmission forwarding to the remote WTRU including a resource mapping configuration, and third configuration information indicating signal quality parameters for relaying a received LP-WUS to the remote WTRU, as described above.

As further shown in FIG. 8, process 800 may include receiving, from the wireless network, an indication to start monitoring the LP-WUS of the remote WTRU at 806. For example, WTRU may receive, from the wireless network, an indication to start monitoring the LP-WUS of the remote WTRU, as described above. As also shown in FIG. 8, process 800 may include determining that the signal quality parameters for relaying a received LP-WUS are satisfied at 808. For example, WTRU may determine that the signal quality parameters for relaying a received LP-WUS are satisfied, as described above. As further shown in FIG. 8, process 800 may include, at 810, transmitting, to the wireless network, an acknowledgement for activation of LP-WUS relaying in response to the indication to start monitoring the LP-WUS of the remote WTRU. For example, WTRU may transmit, to the wireless network, an acknowledgement for activation of LP-WUS relaying in response to the indication to start monitoring the LP-WUS of the remote WTRU, as described above. As also shown in FIG. 8, process 800 may include monitoring for a LP-WUS based on the remote WTRU configured resources and a low power synchronization signal (LP-SS) transmitted to the remote WTRU using the remote WTRU configured resources at 812. For example, WTRU may monitor for a LP-WUS based on the remote WTRU configured resources and a low power synchronization signal (LP-SS) transmitted to the remote WTRU using the remote WTRU configured resources, as described above. As further shown in FIG. 8, process 800 may include, at 814, receiving, from the wireless network, a LP-WUS addressed to the remote WTRU. For example, WTRU may receive, from the wireless network, a LP-WUS addressed to the remote WTRU, as described above. As also shown in FIG. 8, process 800 may include determining uplink (UL) resources for transmitting the received LP-WUS to the remote WTRU according to a mapping between resources of the received LP-WUS and configured UL resources based on the resource mapping configuration at 816. For example, WTRU may determine uplink (ul) resources for transmitting the received LP-WUS to the remote WTRU according to a mapping between resources of the received LP-WUS and configured ul resources based on the resource mapping configuration, as described above. As further shown in FIG. 8, process 800 may include, at 818, transmitting the received LP-WUS to the remote WTRU according to the determined UL resources. For example, WTRU may transmit the received LP-WUS to the remote WTRU according to the determined ul resources, as described above.

Process 800 may include additional implementations, such as any single implementation or any combination of implementations described below and/or in connection with one or more other processes described elsewhere herein. In a first implementation, the first configuration parameters for monitoring the LP-WUS of the remote WTRU include: one or more LP-WUS resource occasions, time and frequency resources of the remote WTRU, an identification of the remote WTRU, or a subgroup identification of the remote WTRU.

In a second implementation, alone or in combination with the first implementation, the second configuration parameters for LP-WUS transmission forwarding to the remote WTRU further include one or more of: a minimum delay between reception of the LP-WUS addressed to the remote WTRU and forwarding the LP-WUS to the remote WTRU, a maximum delay between reception of the LP-WUS addressed to the remote WTRU and forwarding the LP-WUS to the remote WTRU, or relay parameters for LP-WUS forwarding transmissions and LP-SS for the remote WTRU.

In a third implementation, alone or in combination with the first and second implementation, the relay parameters for LP-WUS forwarding transmissions and the LP-SS for the remote WTRU include at least one of: a LP-WUS format including a wave form type, a specific timing for the remote WTRU, and a specific power for the remote WTRU, and where transmitting the received LP-WUS to the remote WTRU is further based on the at least one of the LP-WUS format including the wave form type, the specific timing for the remote WTRU, and the specific power for the remote WTRU.

In a fourth implementation, alone or in combination with one or more of the first through third implementations, the third configuration information indicating signal quality parameters for relaying the received LP-WUS to the remote WTRU include a first set of threshold values configured for the remote WTRU, and a second set of threshold values configured for the first WTRU, where the first set of threshold values includes a first subset of threshold values for LR low power radio (LR) activation and MR deactivation, and a second subset of threshold values for MR activation and LR deactivation, and the second set of threshold values includes a third subset of threshold values for LR activation and MR deactivation, and a fourth subset of threshold values for MR activation and LR deactivation.

In a fifth implementation, alone or in combination with one or more of the first through fourth implementations, determining the signal quality parameters for relaying the received LP-WUS are satisfied is based on one of: network measurements and the first set of threshold values and the second set of threshold values, either alone or in combination; or first WTRU measurements of the first set of threshold values and the second set of threshold values, either alone or in combination.

In a sixth implementation, alone or in combination with one or more of the first through fifth implementations, the first set of threshold values are different from the second set of threshold values.

A seventh implementation, alone or in combination with one or more of the first through sixth implementations, process 800 further includes stopping the monitoring the LP-WUS of the remote WTRU when detecting LR measurements of the remote WTRU are less than a corresponding second subset threshold value for LR deactivation, or the detecting LR measurements of the first WTRU are less than a corresponding fourth threshold value for LR deactivation.

An eighth implementation, alone or in combination with one or more of the first through seventh implementations, process 800 further includes transmitting, to the wireless network, a notification message to stop monitoring the LP-WUS of the remote WTRU when detecting LR measurements of the remote WTRU are less than the corresponding second subset threshold value for LR deactivation, or the detecting LR measurements of the first WTRU are less than the corresponding fourth threshold value for LR deactivation.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A method performed in first wireless transmit/receive unit (WTRU), the method comprising:
transmitting, to a wireless network, capability information indicating a capability to support low power wake-up signal (LP-WUS) forwarding;
receiving, from the wireless network, a configuration message for a remote WTRU to enable LP-WUS coverage extension for the remote WTRU, the configuration message including first configuration parameters for monitoring a LP-WUS of the remote WTRU, the first configuration parameters including remote WTRU configured resources, second configuration parameters for LP-WUS transmission forwarding to the remote WTRU including a resource mapping configuration, and third configuration information indicating signal quality parameters for relaying a received LP-WUS to the remote WTRU;
receiving, from the wireless network, an indication to start monitoring the LP-WUS of the remote WTRU;
determining that the signal quality parameters for relaying a received LP-WUS are satisfied;
transmitting, to the wireless network, an acknowledgement for activation of LP-WUS relaying in response to the indication to start monitoring the LP-WUS of the remote WTRU;
monitoring for a LP-WUS based on the remote WTRU configured resources and a low power synchronization signal (LP-SS) transmitted to the remote WTRU using the remote WTRU configured resources;
receiving, from the wireless network, a LP-WUS addressed to the remote WTRU;
determining uplink (UL) resources for transmitting the received LP-WUS to the remote WTRU according to a mapping between resources of the received LP-WUS and configured UL resources based on the resource mapping configuration; and
transmitting the received LP-WUS to the remote WTRU according to the determined UL resources.

2. The method of claim 1, wherein the first configuration parameters for monitoring the LP-WUS of the remote WTRU include: one or more LP-WUS resource occasions, time and frequency resources of the remote WTRU, an identification of the remote WTRU, or a subgroup identification of the remote WTRU.

3. The method of claim 2, wherein the second configuration parameters for LP-WUS transmission forwarding to the remote WTRU further include one or more of: a minimum delay between reception of the LP-WUS addressed to the remote WTRU and forwarding the LP-WUS to the remote WTRU, a maximum delay between reception of the LP-WUS addressed to the remote WTRU and forwarding the LP-WUS to the remote WTRU, or relay parameters for LP-WUS forwarding transmissions and LP-SS for the remote WTRU.

4. The method of claim 3, wherein the relay parameters for LP-WUS forwarding transmissions and the LP-SS for the remote WTRU include at least one of: a LP-WUS format including a wave form type, a specific timing for the remote WTRU, and a specific power for the remote WTRU, and wherein transmitting the received LP-WUS to the remote WTRU is further based on the at least one of the LP-WUS format including the wave form type, the specific timing for the remote WTRU, and the specific power for the remote WTRU.

5. The method of claim 1, wherein the third configuration information indicating signal quality parameters for relaying the received LP-WUS to the remote WTRU include a first set of threshold values configured for the remote WTRU, and a second set of threshold values configured for the first WTRU, wherein the first set of threshold values includes a first subset of threshold values for LR low power radio (LR) activation and MR deactivation, and a second subset of threshold values for MR activation and LR deactivation, and the second set of threshold values includes a third subset of threshold values for LR activation and MR deactivation, and a fourth subset of threshold values for MR activation and LR deactivation.

6. The method of claim 5, wherein determining the signal quality parameters for relaying the received LP-WUS are satisfied is based on one of: network measurements and the first set of threshold values and the second set of threshold values, either alone or in combination; or first WTRU measurements of the first set of threshold values and the second set of threshold values, either alone or in combination.

7. The method of claim 6, wherein the first set of threshold values are different from the second set of threshold values.

8. The method of claim 6, further comprising: stopping the monitoring the LP-WUS of the remote WTRU when detecting LR measurements of the remote WTRU are less than a corresponding second subset threshold value for LR deactivation, or the detecting LR measurements of the first WTRU are less than a corresponding fourth threshold value for LR deactivation.

9. The method of claim 8, further comprising: transmitting, to the wireless network, a notification message to stop monitoring the LP-WUS of the remote WTRU when detecting LR measurements of the remote WTRU are less than the corresponding second subset threshold value for LR deactivation, or the detecting LR measurements of the first WTRU are less than the corresponding fourth threshold value for LR deactivation.

10. A wireless transmit/receive unit (WTRU) comprising:
processor circuitry; and
a transceiver coupled to the processor circuitry and configured to:
transmit, to a wireless network, a capability information message indicating a capability to support low-power wake-up signal (LP-WUS) forwarding;
receive, from a wireless network, a configuration message for a remote WTRU to enable LP-WUS coverage extension for the remote WTRU, the configuration message including, first configuration parameters for monitoring a LP-WUS of the remote WTRU, the first configuration parameters including remote WTRU configured resources, second configuration parameters for LP-WUS transmission forwarding to the remote WTRU including a resource mapping configuration, and third configuration information indicating signal quality parameters for relaying a received LP-WUS to the remote WTRU; and
receive, from the wireless network, an indication to start monitoring the LP-WUS of the remote WTRU;
the processor circuitry configured to determine that the signal quality parameters for relaying a received LP-WUS to the remote WTRU are satisfied;
the transceiver configured to:
transmit, to the wireless network, an acknowledgement for activation of LP-WUS relaying in response to the indication to start monitoring the LP-WUS of the remote WTRU;
monitor for a LP-WUS based on the remote WTRU configured resources and a low power synchronization signal (LP-SS) transmitted to the remote WTRU using the remote WTRU configured resources; and
receive, from the wireless network, a LP-WUS addressed to the remote WTRU;
the processor circuitry configured to determine uplink (UL) resources to transmit the received LP-WUS to the remote WTRU according to a mapping between resources of the received LP-WUS and configured UL resources based on the resource mapping configuration; and
the transceiver configured to transmit the received LP-WUS to the remote WTRU according to the determined UL resources.

11. The WTRU of claim 10, wherein the first configuration parameters for monitoring the LP-WUS of the remote WTRU include: one or more LP-WUS resource occasions, time and frequency resources of the remote WTRU, an identification of the remote WTRU, or a subgroup identification of the remote WTRU.

12. The WTRU of claim 11, wherein the second configuration parameters for LP-WUS transmission forwarding to the remote WTRU further include one or more of: a minimum delay between reception of the LP-WUS addressed to the remote WTRU and forwarding the LP-WUS to the remote WTRU, a maximum delay between reception of the LP-WUS addressed to the remote WTRU and forwarding the LP-WUS to the remote WTRU, or relay parameters for LP-WUS forwarding transmissions and LP-SS for the remote WTRU.

13. The WTRU of claim 12, wherein the relay parameters for LP-WUS forwarding transmissions and the LP-SS for the remote WTRU includes at least one of: a LP-WUS format including a wave form type, a specific timing for the remote WTRU, and a specific power for the remote WTRU, and wherein transmitting the received LP-WUS to the remote WTRU is further based on the at least one of the LP-WUS format including the wave form type, the specific timing for the remote WTRU, and the specific power for the remote WTRU.

14. The WTRU of claim 10, wherein the third configuration information indicating signal quality parameters for relaying the received LP-WUS to the remote WTRU includes a first set of threshold values configured for the remote WTRU, and a second set of threshold values configured for the WTRU, wherein the first set of threshold values includes a first subset of threshold values for LR low power radio (LR) activation and MR deactivation, and a second subset of threshold values for MR activation and LR deactivation, and the second set of threshold values includes a third subset of threshold values for LR activation and MR deactivation, and a fourth subset of threshold values for MR activation and LR deactivation.

15. The WTRU of claim 14, wherein the processor circuitry is further configured to:
measure the signal quality parameters for relaying a received LP-WUS; and
determine that the signal quality parameters for relaying the received LP-WUS are satisfied based on one of: network measurements and the first set of threshold values and the second set of threshold values, either alone or in combination; or the measured signal quality parameters for relaying a received LP-WUS including the first set of threshold values and the second set of threshold values, either alone or in combination.

16. The WTRU of claim 15, wherein the first set of threshold values are different from the second set of threshold values.

17. The WTRU of claim 15, wherein the processor circuitry is further configured to stop monitoring the LP-WUS of the remote WTRU when detecting LR measurements of the remote WTRU are less than a corresponding second subset threshold value for LR deactivation, or the detecting LR measurements of the WTRU are less than a corresponding fourth threshold value for LR deactivation.

18. The WTRU of claim 17, wherein the transceiver is further configured to transmit, the wireless network, a notification message to stop monitoring the LP-WUS of the remote WTRU when the processor circuitry detects the LR measurements of the remote WTRU are less than the corresponding second subset threshold value for the LR deactivation, or detects the LR measurements of the WTRU are less than the corresponding fourth threshold value for the LR deactivation.
